(19) United States
(12) Patent Application Publication
(10) Pub. No.: US 2006/0281530 A1
(43) Pub. Date: Dec. 14, 2006

(54) Gaming device with organic light emitting diodes and method of use

(75) Inventors: Jerald C. Seelig, Absecon, NJ (US); Lawrence M. Henshaw, Hammonton, NJ (US)

Correspondence Address: IAN F. BURNS & ASSOCIATES, P.O. BOX 71115, RENO, NV, 89570, US

(73) Assignee: AC Coin and Slot Service Company, Pleasantville, NJ (US)

(21) Appl. No.: 11/399,934

(22) Filed: Apr. 7, 2006

Related U.S. Application Data
(60) Provisional application No. 60/669,649, filed on Apr. 8, 2005.

(51) Int. Cl. A63F 13/00

(52) U.S. Cl. 463/20

(57) ABSTRACT

A gaming device has a primary game that includes several reels. An organic light emitting diode display is mounted to at least one of the reels. A bonus game is mounted in association with the primary game. A method is also disclosed for allowing a player to play a primary gaming device. The primary gaming device provides at least one bonus qualifying event. At least one symbol is displayed on an organic light emitting diode display. If the at least one bonus qualifying event occurs, a bonus game is activated. The player is allowed to play the bonus game and any prizes are awarded to the player. In another embodiment, the organic light emitting diode display is mounted with a bonus game and can be used to display a bonus game outcome.

### CROSS REFERENCE TO RELATED APPLICATIONS

This application claims priority to U.S. provisional patent application Ser. No. 60/669,6494, filed Apr. 8, 2005, entitled “Gaming Device Reel Assembly,” the contents of which are herein incorporated by reference.

### FIELD OF THE INVENTION

The present invention relates to a gaming device, and a method of use. More specifically, the gaming device includes a primary game, a bonus game and an organic light emitting diode display that may be used with either game.

### BACKGROUND

Gaming Devices

Gaming devices are well known in the art and a large variety of gaming devices have been developed. In general, gaming devices allow users or players to play a game. In many casino-type gaming devices, the outcome of the game depends, at least in part, on a randomly generated event. For example, a gaming device may use a random number generator to generate a random or pseudo-random number. The random number may then be compared to a predefined table to determine the outcome of the event. If the random number falls within a certain range of numbers on the table, the player may win a predefined prize. The table may also contain display information that allows the gaming device to generate a display that corresponds to the outcome of the game. The gaming device may present the outcome of the game on a large variety of display devices, such as mechanical spinning reels or video screens.

Unfortunately, mechanical spinning reels utilize mechanical mechanisms such as stepper motors that are subject to wear and breakdown over time. In addition, mechanical reels are limited in the number of indicia or symbols that they can display. Only the indicia that are printed on the outer circumference of the wheel are visible for display. Once printed, these indicia are permanent and cannot be changed.

Bonus Prizes

Some gaming devices award bonuses in addition to prizes that are awarded in the primary game. A bonus can be defined as an additional prize that is awarded to the player when a predefined event occurs. An example of a bonus game can be found in U.S. Pat. No. 5,848,932 issued to Adams. One of the gaming devices described in this document comprises three spinning reels and a spinning wheel bonus display. When predetermined indicia are displayed on the spinning reels of the primary game, the wheel can be activated to indicate a bonus prize. The bonus prize is awarded in addition to any prizes awarded in the primary game.

In another embodiment described in this document, the gaming device includes a container having one or more movable objects and a transport device for transporting the one or more movable objects within the container. When predetermined symbols are displayed on the reels of the primary game, the transport device can be activated to transport the movable objects while the player is allowed to play the bonus game.

Generally, bonus prizes are offered in such games in order to increase the excitement and enjoyment experienced by players. This attracts more players to the game and encourages players to play longer. When gaming devices attract more players and the players play longer, they tend to be more commercially successful relative to other gaming devices.

Display Devices

In addition, highly visible display devices are utilized on gaming devices in order to attract players. Once players are attracted to the gaming device, they tend to play longer because the display device enhances the stimulation and excitement experienced by players. It is, therefore, desirable for gaming devices to incorporate highly visible display devices.

The applicants believe that display devices tend to be more successful if they are a derivation of a well-known game or theme. They are more successful because players tend to be drawn to games that they instantly recognize. Many players are reluctant to try completely new games because they must spend time to learn the new game. It is; therefore, desirable to provide display devices that are based on well-known games or themes.

The applicants also believe that display devices tend to be more successful if they utilize physical objects rather than simulations. Although video devices and electronic signs can be used for display devices, players are more attracted to display devices that utilize physical objects. Physical objects can be even more effective display devices if they are movable and they are used in combination with lights and sounds. With the movement of objects within display devices, it is advantageous to use transport devices that will attain maximum effectiveness while occupying a minimum amount of space. It is important to minimize the amount of occupied space because a smaller gaming device generally corresponds to an overall lower cost.

Keno

Upon an initial examination, it would appear to the applicants that the display device of Keno is an excellent choice for a display device for gaming devices. Keno is well known to the playing public, and it utilizes a highly visible and attractive display device. The display device comprises a container with a plurality of numbered balls. The balls in the container are agitated or jumbled, usually by a jet of air, to a state where they ricochet off of the walls of the container.

In the game of Keno, players select numbers that may be drawn from the Keno display device. The display device jumbles or mixes numbered balls in the container and then draws a predetermined number of balls from the container. Players are paid based on the number of balls drawn from the display device that match the numbers they selected.

However, before the present invention, the Keno display device has been unsuitable for use with gaming devices. One of the reasons this is so is because Keno is susceptible to environmental influences. An important aspect of any gaming device is resistance to environmental influences that could affect the results of the game. However, as the balls are jumbled in the Keno ball device, static electricity, dust, and contaminants build up on the balls. This may cause the balls to stick to each other or to components in the display device thereby influencing the randomness of the game. Furthermore, the balls used in Keno displays may have slightly different weights or sizes that subtly affect the outcome of the game.

Another reason the game of Keno has been unsuitable as an indicator for a gaming device is that it requires a great deal of human involvement. In many Keno games, human operators are required to read the numbers of the Keno balls as they are selected and input the numbers into a computer or display. Furthermore, operators must regularly clean the Keno balls and the Keno devices to keep dust and contaminants from building up on the balls. Not only does this require far too much human involvement for an automated gaming device (the greater the human involvement, the greater the cost of operating the game), the game is also susceptible to tampering and cheating.

Because of their susceptibility to environmental influences and tampering and their dependence on human operators and maintenance personnel, Keno games are not allowed in at least one major gaming jurisdiction. Furthermore, these disadvantages have prevented Keno display devices and other devices that use jumbled balls from being adapted for use with gaming devices. The applicants have discovered that what has long been needed is a means for adapting jumbled ball display devices for use with gaming devices. Although reference is made to the game of Keno, it is to be understood that the present invention may be used with almost any type of ball,jumbled ball, or action unit display device, such as lottery balls for example.

Bingo

Similar to Keno, some Bingo game devices utilize a container with a plurality of numbered balls. The balls in the container are agitated or jumbled, usually by rotation of the container. Players receive cards with a grid of cells or spaces. A randomly determined number of symbol is printed in each cell. As balls are randomly drawn from the container, players mark cells on their cards when the numbers on the ball correspond to numbers in the cell. The first player to fill a column, row, or diagonal line on the card with marks, wins the game. Although Bingo devices are well known and provide an attractive display, they suffer from the same problems as Keno devices. Therefore, before the present invention, they have not been thought to be acceptable for use with gaming devices.

Jumbled Ball Displays

Two references that have attempted to utilize jumbled ball displays are U.S. Pat. No. 4,871,171 issued to Rivero and U.S. Pat. No. 5,380,007 issued to Travis et al. Rivero appears to disclose a game device with means for simulating the release of a ball. In this reference, a rotating drum 2 is provided with numbered balls 17. As the drum rotates, a ball is released into a transparent tube 16.

However, Rivero is not intended to show the player the ball that is released from the drum. Rather, the ball is held in the tube, out of view of the player, and an electronic simulation of the ball number is presented in a window 9. This is intended to give the player “the impression” that the ball has been counted. Rivero fails to disclose or suggest displaying actual balls to the player to indicate the outcome of the game or the value of a prize. In addition, in the Rivero device the balls are in a cage and quite exposed to the environment and tampering. The ball cage of Rivero is also mounted on the front side and well below the top of the gaming machine, hiding the ball cage from view of potential game players who are not in position to see the front side of the machine.

Travis et al. appear to disclose a video lottery gaming device with numbered balls 48. However, all of the balls are simulations generated by software and no physical balls are displayed to the player. Travis et al. also fails to disclose or suggest displaying actual balls to the player to indicate the outcome of the game or the value of a prize.

One of the disadvantages with Rivero and Travis et al. is that no actual physical balls are used to display the outcome of a game. This is less desirable because players like to see physical objects rather than electronic simulations of the physical objects. Moreover, players tend to believe that a game device is misleading when the device purports to display a simulation of an object rather than the object itself. This is especially true when the object itself is supposedly available for viewing, as is the case in Rivero.

### SUMMARY OF ONE EMBODIMENT OF THE INVENTION

Advantages of One or More Embodiments of the Present Invention

The various embodiments of the present invention may, but do not necessarily, achieve one or more of the following advantages:

the ability to provide game players with a more exciting and desirable gaming experience;

the ability to attract more patrons to play a game;

provide longer play times and a greater payout possibility for a player;

provide greater revenues for gaming operators;

provide a gaming device that utilizes a visually appealing and highly visible display device;

provide a gaming device that includes an organic light emitting diode display;

provide a gaming device with a bonus activating event where several display balls are shown to a game player;

provide a gaming device with a bonus activating event where a prize ball displays a game outcome;

provide a gaming device with a prize wheel and pointer that in combination display a game outcome;

provide a gaming device with a sphere and pointer that in combination display a game outcome;

provide a gaming device with a belt and indicator that in combination display a game outcome;

provide a primary game with an organic light emitting diode display and a bonus game;

provide a gaming device that replaces spinning reels with an organic light emitting diode display;

provide a gaming device that includes an organic light emitting diode display that rotates;

provide a gaming device that includes an organic light emitting diode display that can display a wide variety of indicia, symbols or bonus indicators; and

provide a gaming method that uses an organic light emitting diode display. These and other advantages may be realized by reference to the remaining portions of the specification, claims, and abstract.

### BRIEF DESCRIPTION OF ONE EMBODIMENT OF THE PRESENT INVENTION

The present invention includes a gaming device having a primary game that has several reels. An organic light emitting diode display is mounted to at least one of the reels. A bonus game is mounted in association with the primary game. The present invention also comprises a method for allowing a player to play a primary gaming device. The primary gaming device further provides at least one bonus qualifying event. At least one symbol is displayed on an organic light emitting diode display. If the bonus qualifying event occurs a bonus game is activated. The player is allowed to play the bonus game and any prizes are awarded to the player.

The present invention includes a gaming device that has a primary game and a bonus game. An organic light emitting diode display is mounted with the bonus game and can display a variety of prize indicia.

The present invention also discloses a method for allowing a player to play a bonus game. A primary game provides a bonus qualifying event. If the bonus qualifying event occurs, a bonus game is activated. An organic light emitting diode display is mounted to the bonus game and can display a prize indicia. The player is allowed to play the bonus game and any prizes are awarded to the player.

The above description sets forth, rather broadly, a summary of one embodiment of the present invention so that the detailed description that follows may be better understood and contributions of the present invention to the art may be better appreciated. Some of the embodiments of the present invention may not include all of the features or characteristics listed in the above summary. There are, of course, additional features of the invention that will be described below and will form the subject matter of claims. In this respect, before explaining at least one preferred embodiment of the invention in detail, it is to be understood that the invention is not limited in its application to the details of the construction and to the arrangement of the components set forth in the following description or as illustrated in the drawings. The invention is capable of other embodiments and of being practiced and carried out in various ways. Also, it is to be understood that the phraseology and terminology employed herein are for the purpose of description and should not be regarded as limiting.

### BRIEF DESCRIPTION OF THE DRAWINGS

FIG. 1A is substantially a front view of the gaming device of the present invention.

FIG. 1B is substantially a side view of an alternative embodiment of the gaming device of the present invention.

FIG. 1C is substantially a front perspective view of three motor driven reels using an organic light emitting diode display.

FIG. 1D is substantially a side view of one of the reels of FIG. 1C.

FIG. 1E is substantially a front perspective view of three stationary reels using an organic light emitting diode display.

FIG. 1F is substantially an alternative embodiment of FIG. 1D using a wireless data transmitter.

FIG. 2A is substantially a schematic diagram of the gaming device of the present invention.

FIG. 2B is substantially a flow chart showing one of the many ways the display device may be operated.

FIG. 2C is substantially a schematic diagram of an alternate prize ball display mechanism for use in the gaming device of FIG. 2A.

FIG. 3 is substantially a top cross sectional view of the preferred ball holder of the present invention taken along line III in FIG. 2A.

FIG. 4 is substantially a top cross sectional view of an alternative ball holder of the present invention.

FIG. 5A is substantially an enlarged view of the ball holder shown in FIG. 2A.

FIG. 5B is substantially a side elevational view of the positioning and display mechanisms of the preferred embodiment of the present invention.

FIG 6 is substantially a schematic diagram of an alternative embodiment of the present invention using multiple stacked ball holders.

FIG. 7 is substantially an alternative display mechanism of the present invention.

FIG. 8 is substantially a schematic representation of a bingo game that may be used with the present invention.

FIG. 9 is substantially a schematic representation of an alternative bingo game that may be used with the present invention.

FIG. 10 is substantially a schematic representation of an alternative bingo game that may be used with the present invention.

FIG. 11 is substantially a schematic representation of a lottery style game that may be used with the present invention.

FIG. 12 is substantially a schematic representation of a player selection game that may be used with the present invention.

FIG. 13 is substantially a front view of an alternative gaming device of the present invention utilizing a rotating wheel and pointer.

FIG. 14 is substantially a schematic diagram of the gaming device of FIG. 13.

FIG. 15 is a flowchart of a gaming method of the present invention.

FIG. 16 is substantially a front view of an alternative gaming device of the present invention utilizing a rotating wheel having an organic light emitting diode display and a pointer.

FIG. 17 is substantially a schematic diagram of the gaming device of FIG. 16.

FIG. 18 is a flowchart of a gaming method of the present invention.

FIG. 19 is a flowchart of a gaming method of the present invention.

FIG. 20 is substantially a front view of an alternative gaming device of the present invention utilizing a rotating sphere and pointer.

FIG. 21 is substantially a schematic diagram of the gaming device of FIG. 20.

FIG. 22 is substantially a front view of an alternative gaming device of the present invention utilizing a rotating belt and pointer.

FIG. 23 is substantially a schematic diagram of the rotating belt of FIG. 22.

FIG. 24 is substantially a schematic diagram of the pointer of FIG. 22.

FIG. 25 is substantially a schematic diagram of the overall gaming device of FIG. 22.

FIG. 26 is a flowchart of a gaming method of the present invention.

FIG. 27 is a flowchart of a gaming method of the present invention.

### DESCRIPTION OF CERTAIN EMBODIMENTS OF THE PRESENT INVENTION

In the following detailed description of the preferred embodiments, reference is made to the accompanying drawings, which form a part of this application. The drawings show, by way of illustration, specific embodiments in which the invention may be practiced. It is to be understood that other embodiments may be utilized and structural changes may be made with out departing from the scope of the present invention.

In the Detailed Description below, the applicants utilize various spatially orienting terms such as “upper,” “lower,” “horizontal,” and “vertical.” It is to be understood that these terms are used for ease of description of the preferred embodiments with respect to the drawings but are not necessarily in themselves limiting or requiring of an orientation as thereby described in the following Detailed Description.

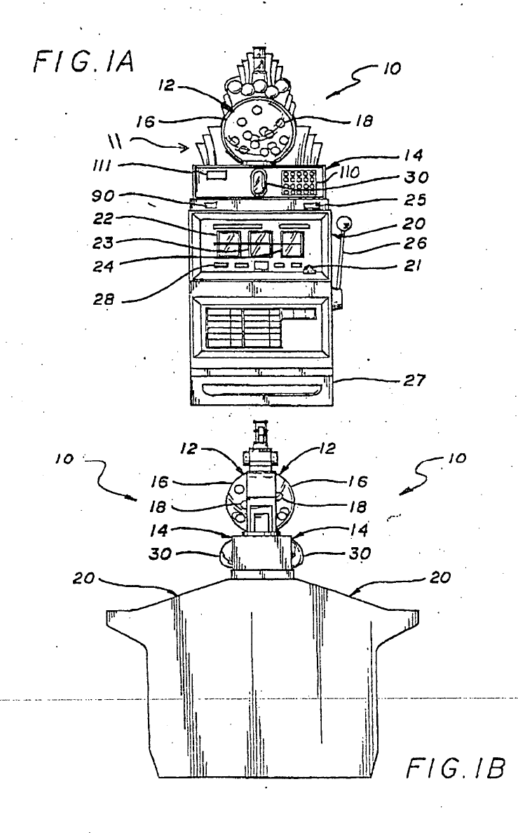

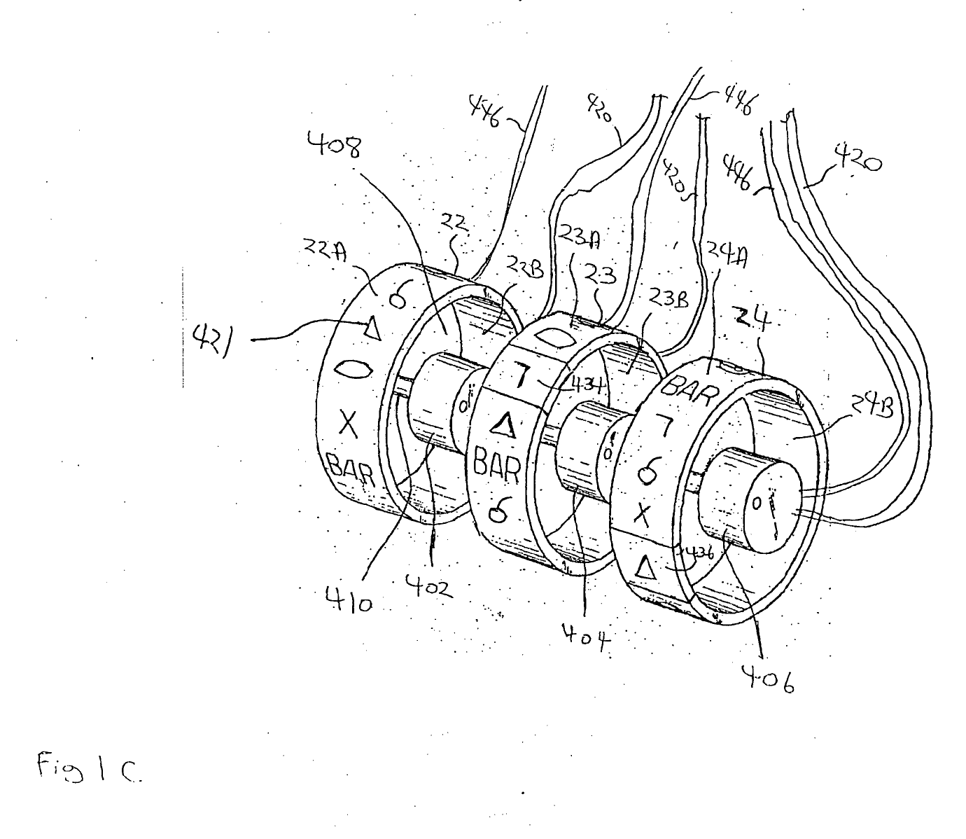

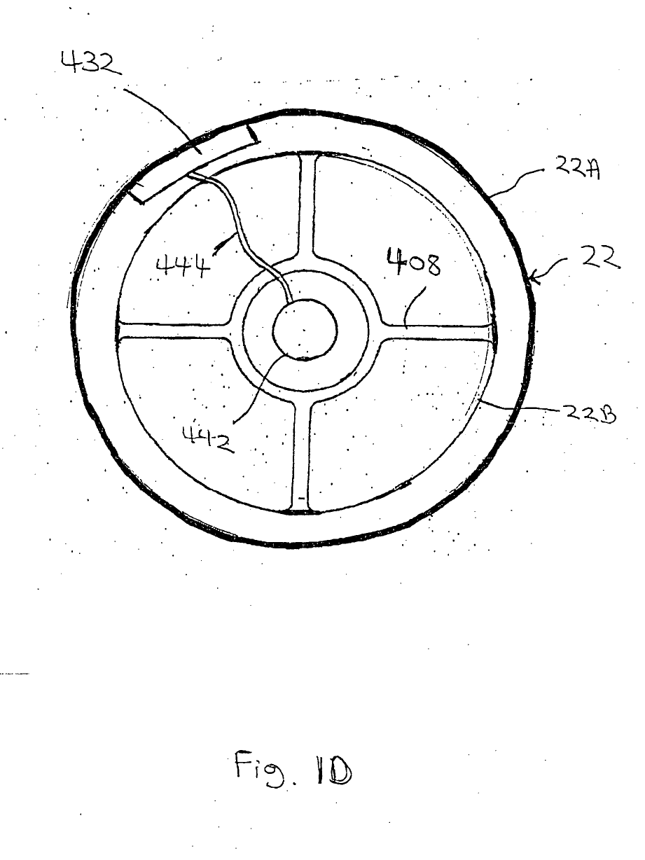

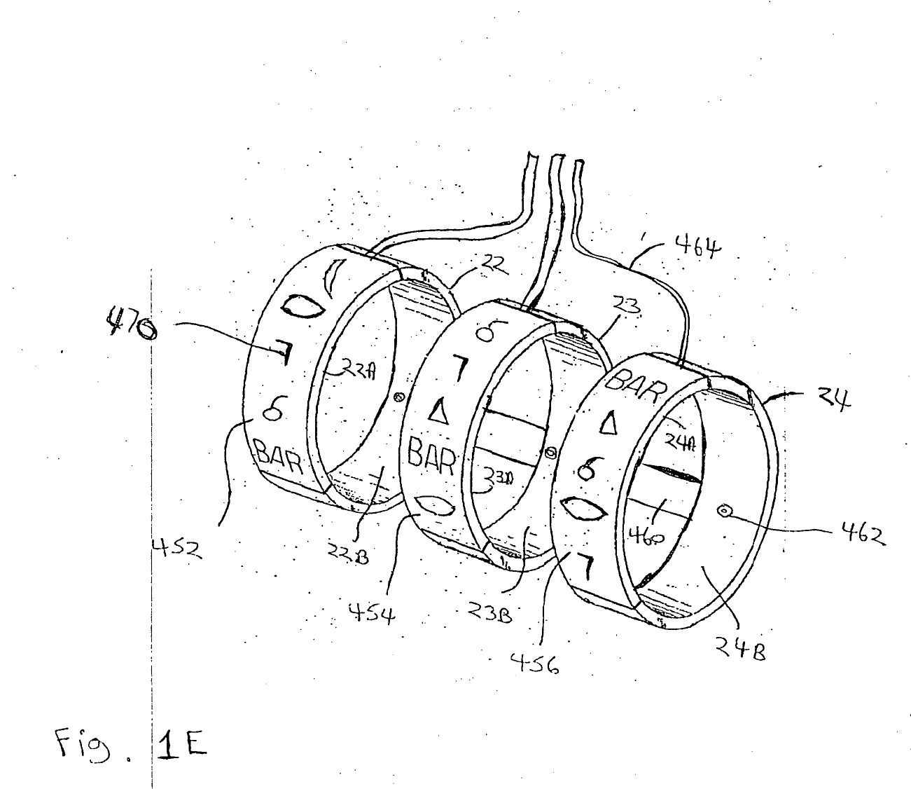

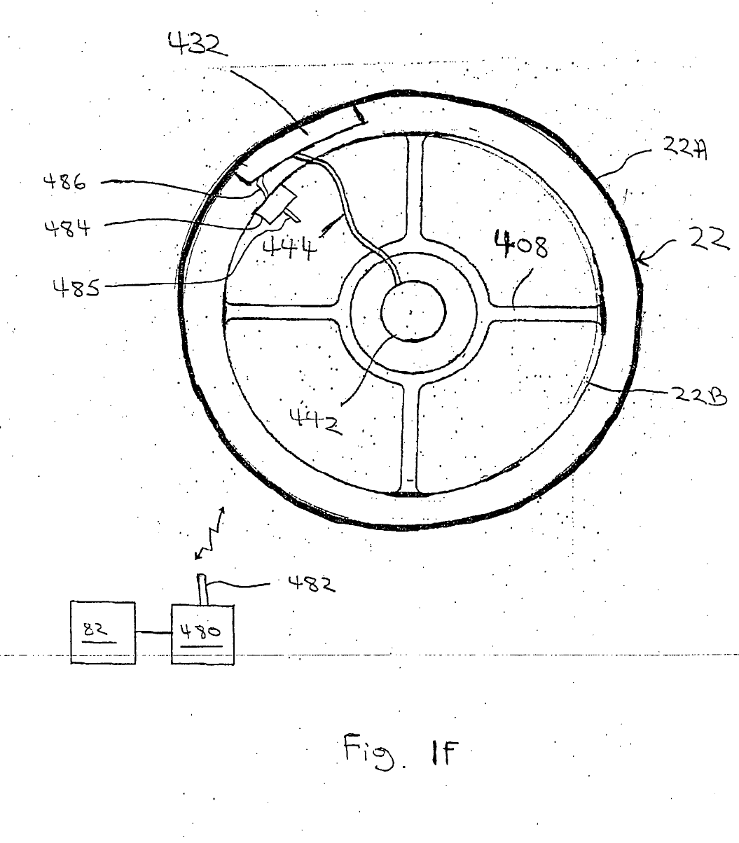

As seen in FIG. 1A one embodiment disclosed herein comprises a gaming device, generally indicated by reference number 10. Gaming device 10 comprises a bonus game or display device 11 and a primary or base game apparatus 20. Display device 11 may comprise a jumbled ball display 12 and a prize display 14.

Game Apparatus

With continuing reference to FIG. 1A, a primary or base game apparatus 20 may be any of a large number of devices that are adapted to allow players to play a game. For example, game apparatus 20 may utilize reel displays, such as reels 22-24 or a video display (not shown), to display outcomes of the game. Means may also be provided for accepting wagers, such as a coin slot 21 or card reader 25, and for awarding prizes, such as a coin dispenser 27. A handle 26 and button 28 are provided for activating game apparatus 20 to begin a game. In at least one embodiment, game apparatus 20 may be an S Plus model gaming device manufactured by International Game Technology in Reno, Nev.

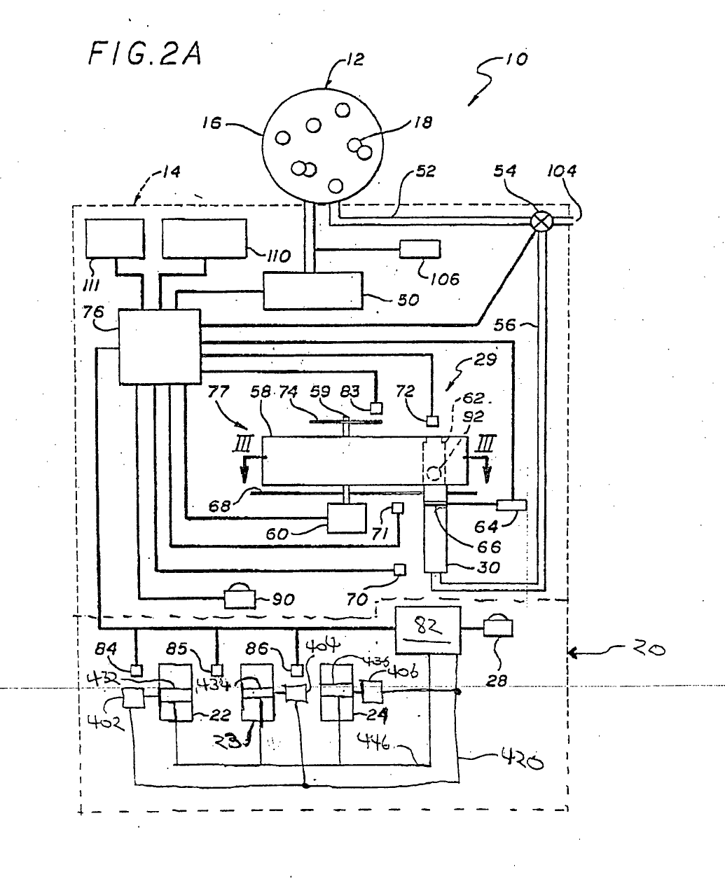

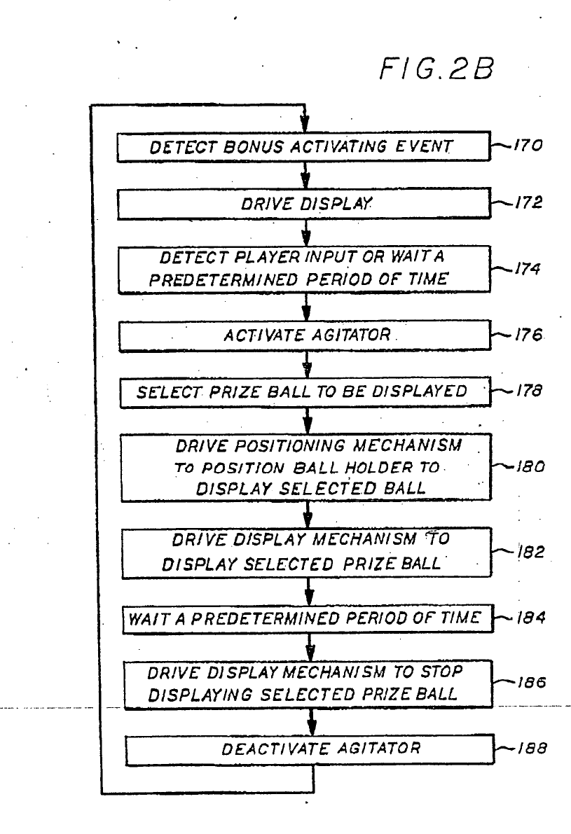

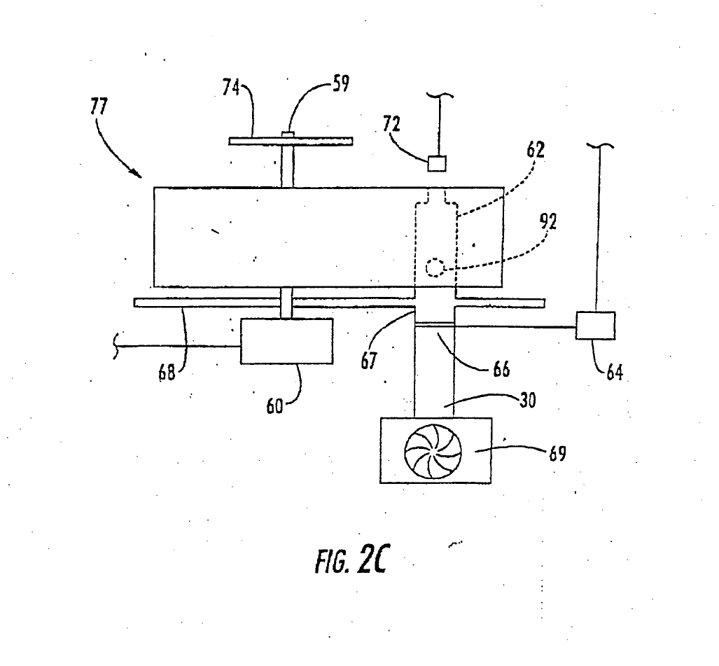

Referring to FIGS. 1C and 1D, game apparatus 20 can include driven reels 22, 23 and 24. Reel 22 has an outer surface 22A and an inner surface 22B. Reel 23 has an outer surface 23A and an inner surface 23B. Reel 24 has an outer surface 24A and an inner surface 24B. Reels 22, 23 and 24 can be made from any suitable material such as metal or plastic. Reels 22-24 each have frames 408 that are attached to a shaft 410. Stepper motors 402, 404 and 406 are attached to shafts 410. Stepper motors 402, 404, and 406 are adapted to rotate reels 22-24. Stepper motors 402, 404 and 406 are in communication with a controller 82 (FIG. 2A) through electrical wires 420. The controller determines and controls the final position that each reel stops at. Various indicia or symbols 421 can be mounted to outer reel surfaces 22A, 23A and 24A.

An organic light emitting diode display can be attached to reels 22-24. An OLED display 432 is attached to reel 22. An OLED display 434 is attached to reel 23 and an OLED display 436 is attached to reel 23. OLED displays 432-436 can be attached to reels 22-26 by any suitable means including the use of an adhesive. As shown in FIG. 1C, OLED displays 432-436 cover a portion of reels 22-24. An organic light emitting diode display is a full-color flat-panel display with a level of brightness, viewing angle, and sharpness that is not possible with traditional flat-panel displays. Organic light emitting diodes are flexible, thin and lightweight making them well suited for mounting to a reel. Organic light emitting diode displays are commercially available.

Organic light emitting diodes are self-luminous, have an unlimited viewing angle, have very high contrast, and much higher speed responses. Organic light emitting diodes have a distinct look that can attract attention to the gaming device. In addition, the organic light emitting diode can offer the gaming operator more choices of symbols to be displayed and possible game outcomes.

One example of a gaming device using an OLED display is shown in U.S. Patent Publication No. 2004/0266515.

Electrical power and signal information is supplied to the OLED displays 432-436 by electrical cables 444. Each display would be connected to one of cables 444. The other end of cable 444 is connected to a rotating slip connector 442. Slip connector 442 includes several electrical contacts that rotate with the shaft of the stepper motor and stationary contacts that make electrical contact to corresponding rotating contacts to provide uninterrupted electrical contact as the reels are rotating. Examples of such contacts are shown in U.S. Pat. Nos. 6,331,117 and 4,583,798. Slip connector 442 can further be connected with electrical wires 446 that are in communication with controller 82 (FIG. 2A).

Alternatively, only electrical power can be supplied to the OLED displays 432-436 through cables 444 and data or signals can be transmitted through a wireless connection. Referring to FIG. 1F, controller 82 is in communication with transmitter 480. Transmitter 450 has an attached antenna 482. Controller 82 and transmitter 480 can be mounted within game apparatus 20. A receiver 484 is mounted to reel 22 on inner surface 22B. Receiver 484 has an antenna 485. A cable 486 is connected between receiver 484 and OLED display 432. Transmitter 480 and receiver 484 can use any suitable type of wireless communication technology including radio frequency, infrared or bluetooth. The use of wireless communication can provide a simple more reliable means of communication with the rotating OLED display.

The use of OLED displays 432-436 provides additional excitement to the game. Controller 82 can present or display a wide variety of symbols on OLED displays 432-436 such as conventional spinning reel indicia. Alternatively, OLED displays 432-436 can be used to indicate the award of a bonus game or the award of special prize such as a progressive jackpot.

An OLED display controller (not shown) selectively provides energization signals to a matrix of X and Y coordinates in the display to create the desired image. Software in conjunction with known display controller technology is used to store a pattern of bits in a memory corresponding to the image to be displayed. One possible display may be a raster scan that selectively energizes the OLED display by rows and columns at a rapid rate.

Game apparatus 20 is preferably controlled by an electronic controller 82 (see FIG. 2A) that utilizes a random number generator. The random number generator produces a random or pseudo random number for each game. The outcome of the game may be determined by comparing the random number to a table of outcomes stored in a memory and accessed by controller 82. A number of different tables of outcomes may be used and different tables may be used for different games. The tables can be designed so that different prizes have different probabilities of being awarded. Such design techniques are well known in gaming. Examples of such designs are shown in U.S. Pat. No. 4,448,419, issued to Telnaes, and U.S. Pat. No. 5,456,465, issued to Durham. Controller 82 causes spinning reels 22-24 in combination with organic light emitting diodes 432-436 to show the outcome of the game that corresponds to the outcome of the random number generator. It is recognized that game apparatus 20 may operate in many other ways and still achieve the objects of the present invention.

Game apparatus 20 may also be capable of producing a bonus-activating event. This event may be many different types of events. For example, a bonus-activating event may comprise displaying a particular symbol, such as a “bonus” symbol, or combination of symbols, such as three “7” symbols, on reels 22-24 and organic light emitting diodes 432-436. If the game being played is poker based, the bonus-activating event may be occurrence of a certain hand, such as a royal flush. Furthermore, a bonus-activating event may occur when a player accumulates a number of symbols or game outcomes over a number of separate game plays. For example, a bonus-activating event may occur when the player receives three “bonus” symbols during a period of time. The bonus-activating event may be based on an external event. For example, a bonus-activating event may occur when a group of players obtain a certain result.

Controller 82 can be connected with OLED displays 432-436 through electrical cables 444. Controller 82 can incorporate and include an OLED display controller for controlling and driving OLED displays 432-436.

Turning now to FIG. 1E an alternative embodiment of reels 22, 23 and 24 are shown. In FIG. 1E, reels 22, 23 and 24 are stationary and do not rotate. Reel 22 has an OLED display 452 attached to outer surface 22A. Reel 23 has an OLED display 454 attached to outer surface 23A. Reel 24 has an OLED display 456 attached to outer surface 24A. Displays 452, 454 and 456 are semi-circular shaped and cover approximately half of each reel surface. Displays 452-456 cover a much larger area of the reels than do displays 432-436. Reels 22-24 can be attached together and to the frame (not shown) of gaming device 20 by a bracket 460. Fasteners 462 can attach reels 22-24 to bracket 460.

Organic light emitting diode displays 452-456 are designed to simulate moving reels by using symbols that are scrolled electronically. The start of a game sequence causes symbols 470 on the OLED displays 452-456 to be scrolled up or down providing an illusion to the game player that reels are actually spinning. OLED displays 452-456 are connected to controller 82 by electrical cables 464. Controller 82 can control the scrolling of the OLED displays. A payline can also be simulated by controller 82 on OLED displays 452-456.

After controller 82 has stopped the scrolling of displays 452-456, the symbols 470 may be changed into any desired image. For example, a winning combination may be highlighted or an award amount may be indicated. Other information can also be presented on OLED displays 452-456 such as qualification for a bonus game, an entertaining presentation or the game players total credits won. Any image that can be displayed on a conventional video display may also be shown on an organic light emitting diode display.

The organic light emitting displays shown in FIGS. 1C, 1D and 1E can provide a game player an enhanced gaming experience and additional game play options for game designers and casino operators. The organic light emitting displays can also eliminate several moving parts within a gaming device providing a high reliability game.

Jumbled Ball Display

Referring back to FIG. 1A, jumbled ball display 2 comprises a container 16 that is adapted to hold a plurality of display balls 18. Container 16 is at least partially transparent allowing players to view display balls 18 inside of the container. Container 16 is made of a transparent material, such as plastic or glass. In the preferred embodiment, container 16 is made of acrylic. Suitable containers of this type maybe obtained from Tripp Plastics of Reno, Nev. However, container 16 may also be a wire cage of a type that is used in some Keno games.

Container 16 may have many different shapes, such as a sphere, cube, cylinder, triangle, etc. In the preferred embodiment, container 16 is substantially spherical with a partially flat back (not shown). The flat back allows container 16 to be large while still allowing gaming device 10 to placed against a wall, another gaming device, or other objects.

Although display balls 18 are preferably similar to Keno balls, many other types of balls may be used. For example, display balls 18 may be ping-pong balls or rubber balls. Display 12 also comprises, an agitator (not shown in FIG. 1) to agitate or jumble display balls 18 within container 16. The agitator may be a stream of air or a mechanical mixing device. The agitator causes the balls to bounce and ricochet off of the walls of container 16. In the preferred embodiment, a stream of air is used as an agitator and container 16 comprises an off center opening for the stream of air. The opening is off center to increase the initial agitation of display balls 18.

Fins (not shown) may also be provided at the bottom of container 16 to help agitate display balls 18. The fins support display balls 18 when they are resting at the bottom of container 16. This helps air circulate underneath display balls 18 to lift and separate the balls. The purpose of jumbled ball display 12 is to attract and entertain players. When display balls 18 are agitated, they produce a vivid display that attracts the attention of people nearby and provides an exciting display for players playing gaming device 10. Display Balls 18 are preferably kept separate from balls used in display device 14.

FIG. 1B represents an alternative embodiment of the present invention in which two gaming devices 10 are placed back to back. Each gaming device 10 comprises a game apparatus 20. Game apparatuses 20, shown in FIG. 1B are known as “slant top” models for their sloping upper surfaces. However, other types of gaming devices, such as the upright game apparatus 20 shown in FIG. 1A, may also be used.

In this embodiment, a separate jumbled ball display 12 is provided for each game apparatus 20. Each jumbled ball display 12 may comprise container 16 in the shape of a hemisphere. Containers 16 may be placed back to back so that the two containers have a spherical appearance when viewed from the side. Other shapes, such as cubes and cylinders, may also be used. A mirror may be placed at the back of each container 16 to enhance the appearance of the jumbled ball displays 12 by reflecting images of jumbled display balls 18 outward toward the players. Containers 16 may also be one single container that is divided in two by a mirror or other partition. Each container 16 has its own independently operated agitator and jumbled display balls 18. Each game apparatus 20 has its own independently operated prize display 14 with display window 30.

Prize Display

Referring to FIGS. 1A and 1B, a bonus game or prize display 14 is adapted to select a prize ball and display the ball to a player. When a bonus-activating event occurs, prize display 14 senses this, selects a prize ball, and displays the ball in a display window 30.

Turning now to FIG. 2A, prize display 14 comprises a controller 76 that is adapted to control the operation of the device. Controller 76 may be one or more computers or processor boards. For example, in the presently implemented embodiment, controller 76 comprises a bonus controller and stepper motor controller. It is recognized that controller 76 may be a single processor or processor board. Furthermore, it is also recognized that controller 76 and controller 82 may be combined in a single processor or processor board.

Controller 76 is adapted to detect when a bonus activating event occurs in game apparatus 20. This may be accomplished by game apparatus controller 82 transmitting a signal to controller 76 that a bonus event has occurred. For example, controller 82 may determine the outcome of each game and when a bonus-activating outcome occurs, it transmits a signal to controller 76. Alternatively, controller 76 may periodically interrogate controller 82.

In FIG. 2A, the embodiment of FIGS. 1C and 1D is shown in the schematic diagram. Controller 82 is in communication with stepper motors 402-406 through cables 420 and is also in communication with OLED displays 432-436 through cables 446. Alternatively, the embodiment of FIG. 1E can also be used.

In another embodiment, one or more sensors may be provided for determining if a bonus activating event has occurred. For example, sensors 84-86 may sense the positions of reels 22-24. When reels 22-24 are in a bonus activating position, controller 76 would sense this position and begin a bonus sequence (described below). Sensors may also be provided external to gaming device 10 to detect external bonus-activating events. In the embodiment of FIG. 1E, where stationary OLED displays 452-456 are used on reels 22-24, sensors 84-86 are not required and may be omitted.

Controller 82 may also transmit a variety of information to controller 76. For example, controller 82 may signal when coins or currency have been inserted, when a game starts, when an error has occurred, and when a sensor detects tampering.

When controller 76 detects a bonus-activating event, it may begin a bonus sequence by activating display 110. Display 110 may comprise many different kinds of display devices, such as video screens, lights, light emitting diodes, etc. Display 110 may comprise its own controller that is adapted to generate a variety of displays.

Display 110 may indicate that a player has qualified for a bonus round and prompt the player to perform an action. In the preferred embodiment, the player is prompted to activate the bonus sequence by pressing input device 90. Input device 90 may be a simple button, a keyboard, or a touch screen display. In the embodiment in which the player must accumulate a number of bonus symbols to qualify for a bonus, display 110 may indicate the number of symbols the player has received.

When controller 76 detects input device 90 being activated, the controller would activate the agitator in jumbled ball display 12. In the preferred embodiment, the agitator comprises blower 50, which blows air into container 16. Alternatively, the agitator may begin automatically and input device 90 may be used to initiate the display sequence. In another embodiment, controller 76 may wait a predetermined time period for the player to activate input device 90. If the player does not activate input device 90 in that time period, controller 76 would automatically activate the display 12 and initiate the display sequence. In yet another embodiment, controller 76 automatically initiates the display sequence in a predetermined time period, independent from input device 90, and input device 90 is only used to activate the jumbled ball display 12. OF course, no input device may be used and controller 76 may automatically activate display 12 and begin the display sequence.

To display a prize ball, controller 76 performs a routine to determine which ball will be displayed. This may be performed by a number of methods that are well known in the art. For example, prize balls 92 maybe sequentially displayed or displayed based on external events, such as certain bonus activating events may always cause the same prize ball to be displayed.

In the preferred embodiment, however, prize balls 92 are randomly selected. Controller 76 generates a random number and then compares the random number to a pay table similar to that described for game apparatus 20 or as described in U.S. Pat. No. 5,823,874, issued to Adams. A simple pay table may appear as follows:

TABLE 1

| Random | Prize Ball | Amount |
|---|---|---|
| Number | Number | Paid |
| 0.00 to 0.50 | 1 | $1.00 |
| 0.51 to 0.75 | 2 | $5.00 |
| 0.76 to 0.95 | 3 | x2 |
| 0.96 to 1.00 | 4 | $1,000.00 |

For example, if the random number generator produced 0.65, prize ball number 2 would be displayed and $5.00 would be awarded to the player. If the random number generator produced 0.80, prize ball number 3 would be displayed. Prize ball number 3 is a multiplier ball that multiplies some amount produced by game apparatus 20. Gaming apparatus 20, for instance, may award $20 and the multiplier ball would multiply this by two, awarding the player $40.

This embodiment is not necessarily limited to the example pay table shown. A greater number of prize balls may be used and, as will be discussed below, a combination of prize balls may be displayed. Furthermore, different kinds of prizes, besides monetary prizes, may be awarded. For example, the prizes may be goods, services or additional games. The goods and services maybe awarded in the form of physical objects, tickets, vouchers, coupons, etc. Additional games may be presented in the form of tickets, such as scratch off lottery tickets. In the embodiments in which tickets, vouchers, and coupons are used, the objects are dispensed using an internally or externally mounted dispenser 111. Such dispensers are well known in the art.

Once controller 76 determines the prize ball to be displayed and the prize to be awarded, the controller activates a positioning mechanism 77. Positioning mechanism 77 is adapted to position a selected prize ball (that is separate from display balls 18) so that it can be displayed. Positioning mechanism 77 may utilize a large variety of devices to achieve its purpose. In the preferred embodiment, all of the prize balls are held in a ball holder 58. Ball holder 58 may be made from a variety of materials, such as plastics, metals, or composites. In one embodiment, ball holder 58 is cast high-density urethane foam that is machined to obtain a precise shape. In the preferred embodiment, ball holder 58 is injection molded plastic.

Prize balls 92 preferably have a similar appearance to display balls 18 in container 16. This creates the illusion that balls displayed in display window 30 originate from container 16. At least one of prize balls 92 have a symbol that is capable of indicating a prize to be awarded to the player.

Prize balls 92 are stored in ball holder 58 in an individually controlled manner so that individual balls can be selectively removed from the ball holder. This allows particular balls with particular symbols or values to be individually manipulated and displayed when desired. This may be accomplished in different ways. In the preferred embodiment, ball holder 58 comprises a chamber 62 for each prize ball 92 stored in the holder. A display mechanism 29 is provided for removing ball 92 stored in chamber 62, displaying the ball, and replacing it in the chamber.

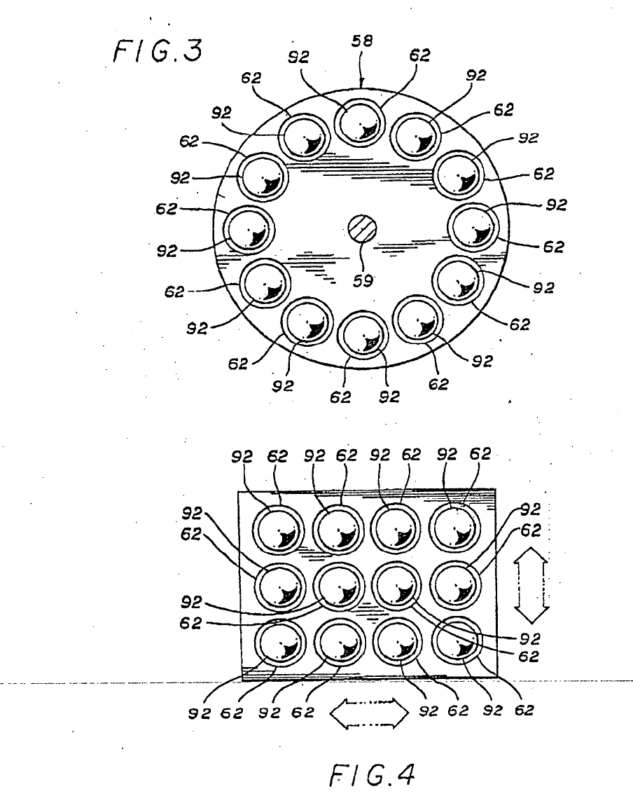

In the preferred embodiment, ball holder 58 is cylindrical as illustrated in FIG. 3. Chambers 62 are positioned outward from a central axis 59 of ball holder 58, near the periphery of the holder. Thus, chambers 62 may be positioned by rotating ball holder 58 around its central axis 59. Ball holder 58 may be provided in different configurations. For example, as shown in FIG. 4, ball holder 61 may be square or rectangular with chambers 62 arranged in rows and columns. In this embodiment, controller 76 is programmed with the location of chambers 62 and ball holder 61 is positioned by moving it laterally and longitudinally. Stepper motors and gears may perform the lateral and longitudinal positioning (not shown).

Returning to FIG. 2, positioning mechanism 77 comprises a stepper motor 60 for rotating holder 58. Wheel 74, rigidly attached to holder 58, and sensor 83, not attached to the holder, are provided for determining the angular position of the holder. Thus, controller 76 can position a ball 92 in holder 58 where it can be removed and replaced by rotating the holder and monitoring its angular position. The angular position of each prize ball 92 is stored in memory in controller 76. Sensor 83 maybe an infrared source and detector and the periphery of wheel 74 may comprise portions with different reflective characteristics, such as physical holes or gaps or absorbent paint lines. Alternatively, an optical flag configuration similar to that described in U.S. Pat. No. 4,911,449, issued to Bertram, may be used.

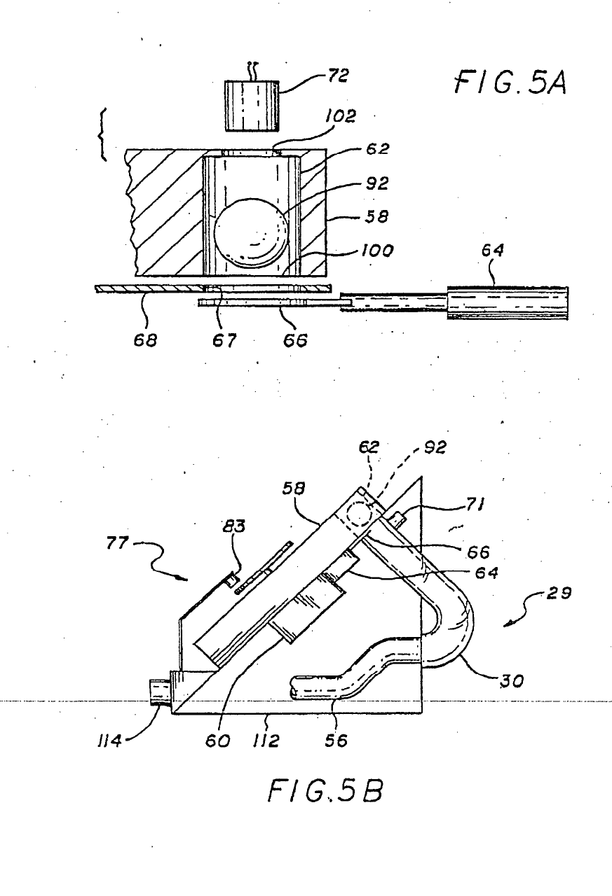

In the preferred embodiment, holder 58 is arranged to allow the force of gravity to remove balls 92 from the holder. Referring now to FIGS. 2A and 5A, each chamber 62 has a lower opening 100 that is large enough for prize ball 92 to pass through. A plate 68 is provided on the lower surface of holder 5S for preventing prize balls 92 from falling out of chambers 62. A hole 67 is provided in one portion of plate 68 for allowing ball 92 to pass through the plate. A gate 66 blocks ball 92 until it is opened by an actuator 64. Gate 66 may cover the entire hole 67 or just a portion of it and it may be operated in a sliding or hinged manner. Actuator 64 may be an electrical solenoid actuator.

FIG. 5B represents a preferred embodiment in which a chassis 112 supports ball holder 58 at approximately a forty-five degree angle to the vertical. Mounting grooves (not shown) may be provided in prize display 14 for slidably receiving chassis 112 and connector 114 may be provided for connecting electrical circuits and devices to power supplies and controller 76. One of the advantages of this embodiment is that positioning mechanism 77 and display mechanism 29 can be easily serviced by removing chassis 112 from prize display device 14.

Referring to FIGS. 2A and 5A, in normal operation, after controller 76 has determined which ball is to be displayed, the controller rotates holder 58 until the desired prize ball 92 is positioned over the plate hole 67. At the appropriate time, controller 76 activates actuator 64 to open gate 66. The force of gravity then pulls prize ball 92 downward through hole 67 into display window 30. Display window 30 may be a chamberwith a transparent or partially transparent wall that allows the player to see selected prize ball 92. In the preferred embodiment, display window 30 comprises a tube that projects outward from the front surface of prize display device 14. This allows players to view prize ball 92 from many different angles and see symbols on the ball. Sensors 70 and/or 71 may be used to verify that prize ball 92 has fallen into display window 30. If sensors 70 and/or 71 do not detect ball 92 in its proper position, controller 76 may enter an error mode.

If the ball is detected in its proper position, controller 76 may cause display 110 to display the prize, if any, that the player has won. Other effects may also be presented, such as pre-recorded sound from speakers. If the actual prize is money, the amount of the prize may be added to the player's credit meter or the prize may be dispensed from dispenser 111 or coin dispenser 27.

After ball 92 has been displayed long enough, controller 76 operates a valve 54 to divert exhaust air from container 16. While blower 50 is in operation, air is allowed to escape container 16 through an exhaust duct 52. Valve 54 is used to divert air from a vent 104 to a display duct 56. Display duct 56 directs air to the bottom of display window 30 where it blows the ball 92 upwards back into chamber 62. An upper opening 102 is provided in chamber 62 for allowing air to escape from the chamber thereby producing an air current. Sensors 72 and/or 71 may be used to verify that ball 92 has returned to chamber 62. If the ball is not detected in its proper position, controller 76 may enter an error mode and an attendant is called. In the preferred embodiment, shown in FIG. 5B, sensor 72 is placed next to the peripheral wall 75 of ball holder 58 and a hole 73 is provided in the peripheral wall next to each chamber 62.

Components of the present invention may be arranged alternatively so that ball display window 30 is located above holder 58 and ball 92 is blown upwards into the display. When valve 54 is closed, the force of gravity pulls ball 92 back into chamber 62. In this alternate embodiment, once ball 92 has returned to chamber 62, controller 76 closes gate 66 by activating actuator 64, turns off blower 50, and waits for the next activating event.

A power failure or power surge could cause actuator 64 to malfunction and improperly open gate 66 while prize display 14 is idle. This would cause prize ball 92 to fall out of chamber 62 into display window 30, thereby giving a false indication that the player had won a prize. In order to prevent this, in the preferred embodiment, at least one chamber 62 does not have prize ball 92 (see FIG. 3). This empty chamber is positioned over hole 67 whenever prize display 14 is idle.

Of course, other methods for agitating display balls 18 may be provided. In addition, other methods for actuating and displaying prize balls 92 may be used. The present invention is not limited to any particular method or apparatus for agitating or displaying display balls 18 and/or prize balls 92.

For example, in certain embodiments, including embodiments discussed further below, display balls 18 may be agitated by actuation of jumbled ball display 12. If display balls 18 are agitated by actuation of jumbled ball display 12, it may be desirable to employ other methods of actuating and displaying prize balls 92. For example, if an air compressor is not needed for agitation of display balls 18, it may be beneficial to modify the method of displaying prize balls 92 so that the air compressor may be eliminated from game apparatus 20.

For example, as illustrated in FIG. 2C, rather than opening valve 54 to divert air to display duct 56 (as in FIG. 2A), an air source or blower can be located below display window 30. For example, a fan 69 may be placed below display window 30. When activated by controller 76, fan 69 operates and creates a stream of air that blows display ball 92 in display window 30 back into chamber 62. Although many fans can be used, one suitable fan is DC brushless fan motor model number BG0703-B044-000 available from Minebea Co., Ltd. of Tokyo, Japan. Of course, other air sources besides fans may be used without departing from the scope of the present invention.

Because some balls are very light, static electricity can cause the balls to stick to each other and to other components. To prevent this, a variety of static discharge devices 106 may be placed in various locations in the present invention. In the preferred embodiment, static discharge device 106 (FIG. 2A) is a bare stranded copper wire with its strands spread out. The wire is placed in the flow of air between agitator 50 and container 16 and wire is attached to a common ground.

Prize display 14 of the present invention may also comprise means for simultaneously displaying a plurality of balls 92. To accomplish this, plate 68 may have multiple holes 67 (not shown), each with its own gate 66 and actuator 64, for supplying balls to multiple display windows. Thus, holder 58 may be positioned so that the appropriate ball is positioned over the appropriate hole 67 for supplying the appropriate display window 30. Alternatively, a plurality of ball holders 58 may be provided, each one supplying balls to a separate display window 30.

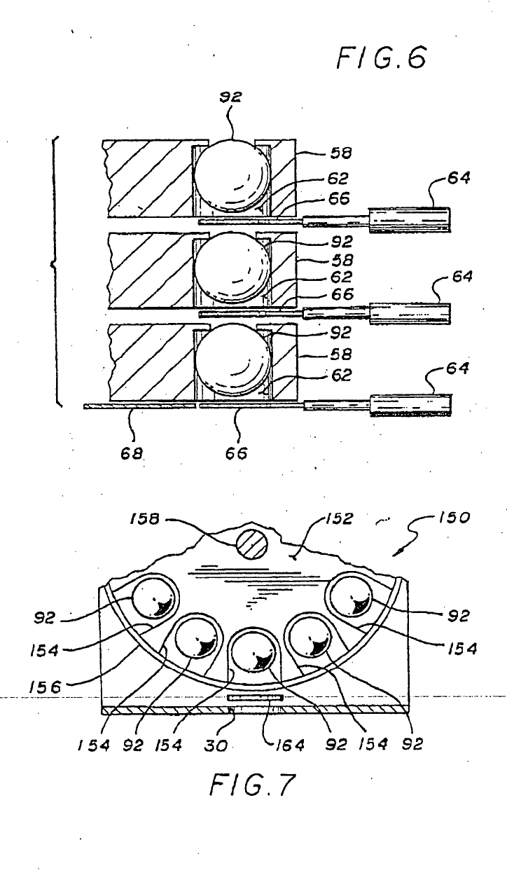

In yet another embodiment, seen in FIG. 6, a plurality of separately controlled ball holders 58 are arranged in a stack. Each ball holder 58 is rotated to a position so that chambers 62 are aligned above display window 30 (FIG. 1A). Gates 66 are then opened and balls 92 are allowed to fall into display window 30. In this embodiment, display window 30 is large enough to display three balls simultaneously. When the display period has ended, balls 92 are blown back into chambers 62 and gates 66 are closed to separate and contain the balls. The action of gates 66 separates prize balls 92 into separate chambers 62.

With multiple balls being displayed, it is possible to use combinations of balls to indicate various bonus outcomes. It is also possible to replace the primary display of a gaming device with selector and prize display device 14. In other words, game apparatus 20 may be entirely replaced with selector and prize display device 14.

As seen in FIG. 7, the present invention comprises an alternative display mechanism 150. Display mechanism 150 comprises a cylindrical ball holder 152 that may be rotated around its central axis 158. Ball holder 152 comprises a plurality of chambers 154 positioned along the periphery of the holder, each chamber is adapted to hold ball 92. Unlike the embodiment described in FIG. 2A, it is not necessary to remove and replace balls 92 from chambers 154. Instead, at least a portion of the outer wall of each chamber 154 comprises a transparent material that allows players to view balls 92 inside the chamber. The transparent wall may comprise a ring of transparent material 156 that surrounds holder 152. A shutter device or door 164 may be provided between display window 30 and holder 152 for blocking the view of players while the holder is rotated. Although this embodiment has the advantage of a simpler mechanism, it may be less entertaining to players because it may be more apparent to the players that balls 92 do not originate from jumbled ball display 12.

As seen in FIG. 1C, a single display device 11 may also be used with a plurality of game apparatus 20. In this embodiment, each game apparatus is in communication with display device 11 by a communication device 104. Communication device 104 may be a network cable, such as an Ethernet cable, and appropriate hardware, such as network interface cards, may be included in display device 11 and game apparatus 20. When one of the game apparatus 20 produces a bonus-activating event, a signal is sent to display device 11. A prize ball may then be selected and displayed as described above.

Turning now to FIG. 2B, the operation of prize display 14 begins when controller 76 detects a bonus-activating event 170. Controller 76 may then drive display 110 to display an appropriate presentation or message 172. As discussed above, controller 76 may wait for player input from input device 90 (shown in FIG. 2A) or it may wait for a predetermined period of time 174. At some point, controller 76 activates the agitator 176 and selects a prize ball to be displayed 178 from ball holder 58. Controller 76 then drives positioning mechanism 77 to position ball holder 58 so that the selected prize ball may be displayed 180 and causes display mechanism 29 to display the selected ball 182. Controller 76 may then wait a predetermined period of time so that the player may see the displayed prize ball 184, after which it causes display mechanism 29 to stop displaying the selected prize ball 186. The agitator is then deactivated 188 and controller 76 returns to a monitoring state to detect the next bonus activating event 170.

In an embodiment,jumbled ball display 12 (see FIG. 1) can be replaced by a video display device (not shown). The video display device can present an image of display balls that are shown to the player. The video display device may be any of a large number of display devices that are well known in the art such as a cathode ray tube or liquid crystal display. The video display can be controlled by controller 76 (see FIG. 2A).

Bingo

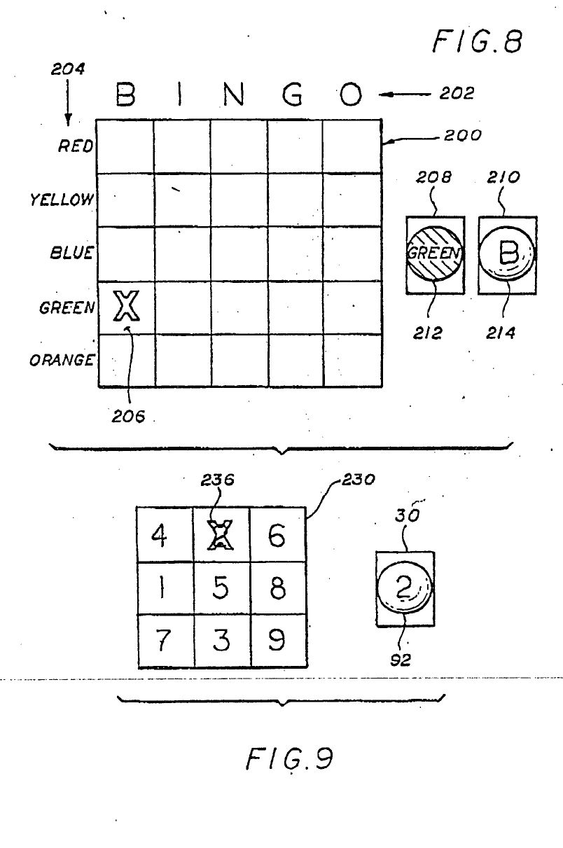

A number of games have been developed to take advantage of the unique features of the present invention. As seen in FIG. 8, one of the games of the present invention comprises a bingo card 200 that may be displayed by a display device, such as an LCD, LED, CRT, or backlit translucent material. The horizontal axis of the card may comprise alphabetic or numeric characters 202 and the vertical axis of the card may comprise colors 204. The alphanumeric characters and the colors may be randomly arranged for each new game, thereby adding variety to the game.

In the Bingo embodiment, prize display 14 comprises two display windows 208 and 210. Each display window 208 and 210 may have its own individual ball holder 58 and prize balls 92 (not shown in FIG. 8). Ball display 208 corresponds to the vertical axis with balls 212 therein displaying colors and ball display 210 corresponds to the horizontal axis with balls therein displaying alphabetic or numeric characters.

In this game, the player wins a bonus prize by filling all of the spaces in a row, column, diagonal line, or combination of rows, columns, and diagonal lines with a symbol. For example, when the player qualifies for a bonus award prize display 14 may randomly select and display a green ball 212 and a ball 214 with the letter “B” on it. A symbol 206 may then be displayed in the space where the “B” column and the green row intersect. Play would continue in this way until the player wins a prize. Once a prize is won, card 200 may be cleared so that the bonus game may be replayed.

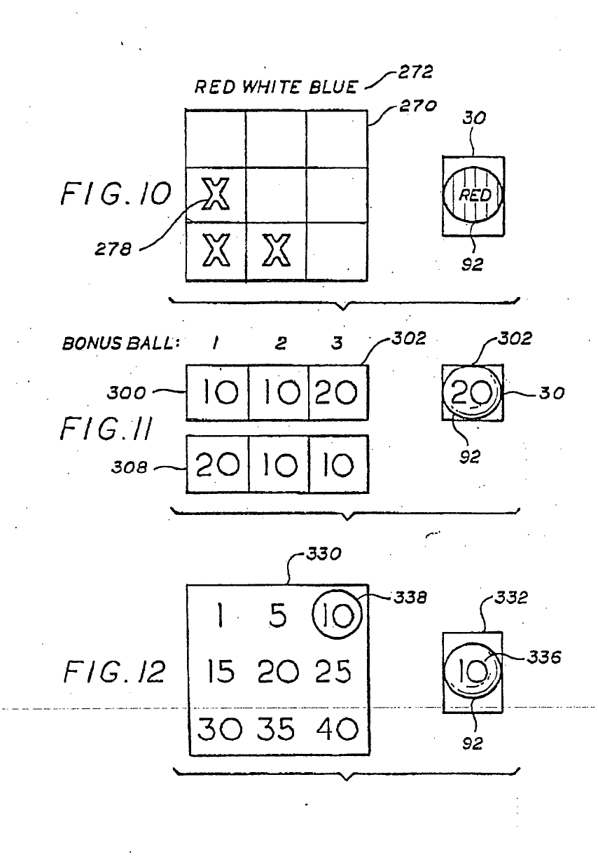

An alternative embodiment of the Bingo bonus game is disclosed in FIG. 9. In this embodiment, a bingo card 230 displays a plurality of symbols. The symbols may be randomly arranged on card 230 for each game. When display window 30 displays a ball 92, displaying a symbol thereon, a symbol 236, such as an “X,” is placed on the corresponding space on bingo card 230.

In another embodiment, shown in FIG. 10, card 270 is divided into a plurality of columns. Each column corresponds with a particular type of symbol or color. The columns preferably have labels 272 on a horizontal axis. As prize display 14 displays a ball 92 in display window 30, a symbol 278 is placed in a space in the column that corresponds to the symbol on the ball. In this embodiment, the player is awarded a prize when all of the spaces in at least one column are filled. Card 270 is then cleared so that play can repeat.

Of course, many different variations of the Bingo bonus game may be utilized with the present invention. For example, larger or smaller cards and different symbols or combination of symbols may be used with the invention.

Lottery

An embodiment may provide a game that follows a format similar to a lottery game. In this embodiment, seen in FIG. 11, prize ball 92 is selected and displayed in display window 30 in the same manner as other embodiments discussed above. Each time a ball is selected, a symbol 302 on the prize ball 92 is recorded in a first symbol display 300. In the example shown in FIG. 11, the number “10” has been recorded in the first and second areas for balls that have been previously selected and the number “20” is displayed in the third area for the most recent ball 92 selected. A second symbol display 308 is provided for displaying a randomly selected set of numbers. The numbers displayed in second display 308 may be generated with a random number generator that is adapted to select only the numbers that may be displayed on prize balls 92. Alternatively, similar to well known lottery games, the player may be allowed to pick the numbers in display 308. Of course, a greater or lesser number of spaces may be provided in displays 300 and 308.

In the preferred lottery embodiment, the player is paid the amount shown on each prize ball 92 as it is displayed. Thus, in the example in FIG. 11, the player would be paid 20 credits or dollars for number 302 that is presented on the currently displayed ball 92. In addition to the prize displayed on ball 92, the player may qualify for an additional amount if the symbols displayed in first symbol display 300 are the same as the symbols displayed in second symbol display 308. In one embodiment, the symbols in first symbol display 300 must be in the same order as the symbols displayed in second symbol display 308. Thus, in the example shown in FIG. 11 the player would not win a prize because the order of the numbers is not the same. In another embodiment, the order of the numbers is irrelevant. Thus, in the example shown in FIG. 11 the player would win a prize because the symbols in first symbol display 300 are the same as the symbols in second symbol display 308. A modified version of the second embodiment would award a larger prize to the player if the order of the numbers in the two displays 300 and 308 were the same. In yet another embodiment, the prize that is awarded to a player is a progressive jackpot of a type that is well known in the art.

Player Selection

In another embodiment, the player selects a symbol or symbols from a list of symbols that the player may receive. Illustrated in FIG. 12, a display device 330 may be provided that displays a plurality of different symbols. When the game begins, the player may be prompted to select one of the possible symbols. In the case of a touch screen, the player may select the symbol by pressing the symbol with the player's finger. Other selection devices, such as buttons, may also be used. A graphical indicator may be used to indicate that the symbol has been selected, such as a circle 338 around the symbol. Once the symbol has been selected, the prize display 14 selects a prize ball and displays it in display window 30. If a symbol 336 on ball 92 matches the symbol selected by the player, the player is awarded a prize. In an alternative embodiment, the player is awarded the prize shown on the ball and the player receives an additional prize if the symbol on the ball matches the symbol selected by the player.

The player selection embodiment of the present invention may be combined with the lottery embodiment of the present invention. In this combination, the player is asked to select a plurality of numbers. If the symbols on the balls selected by prize display 14 are the same as the symbols selected by the player, the player is awarded a prize.

One of the advantages of providing the games discussed above is to increase the excitement and enjoyment of playing gaming device 10. Not only are the games entertaining to view, but they also increase the excitement and enjoyment experienced by players by offering large prizes. Each of the games can be adapted to award large prizes because they are capable of producing low probability events from which the large prizes are awarded.

In addition, the games may be adapted for use as the primary game. Thus, game apparatus 20 maybe completely replaced with the games of the present invention.

Prize Wheel Embodiment

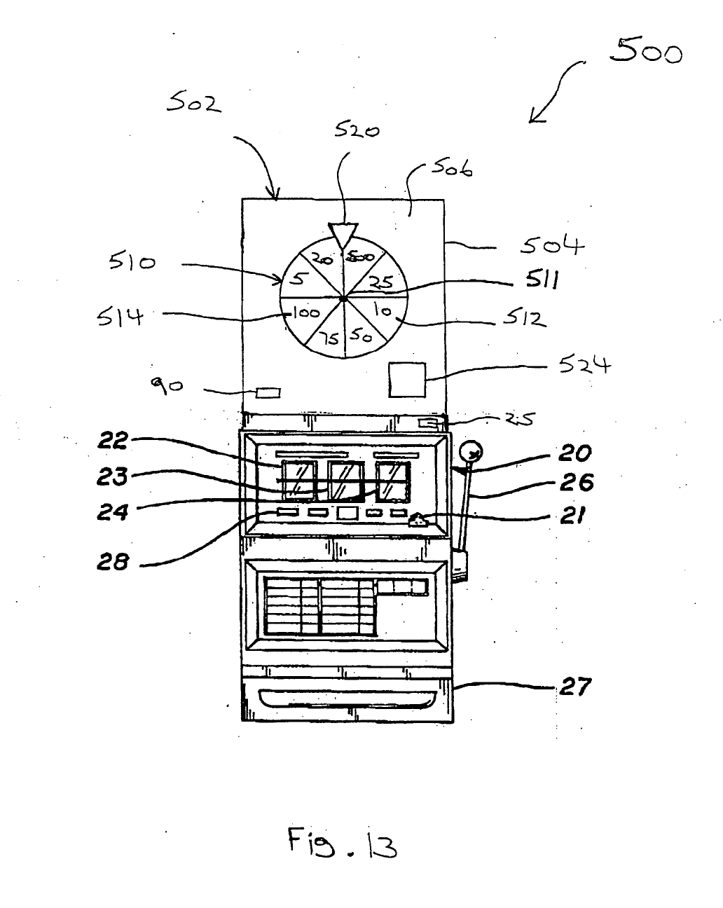

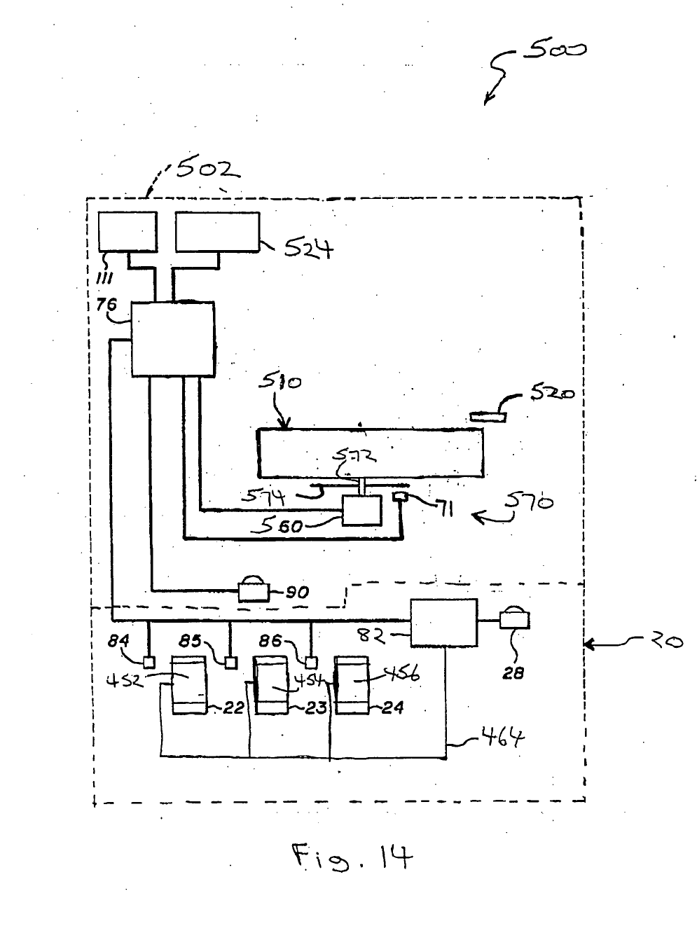

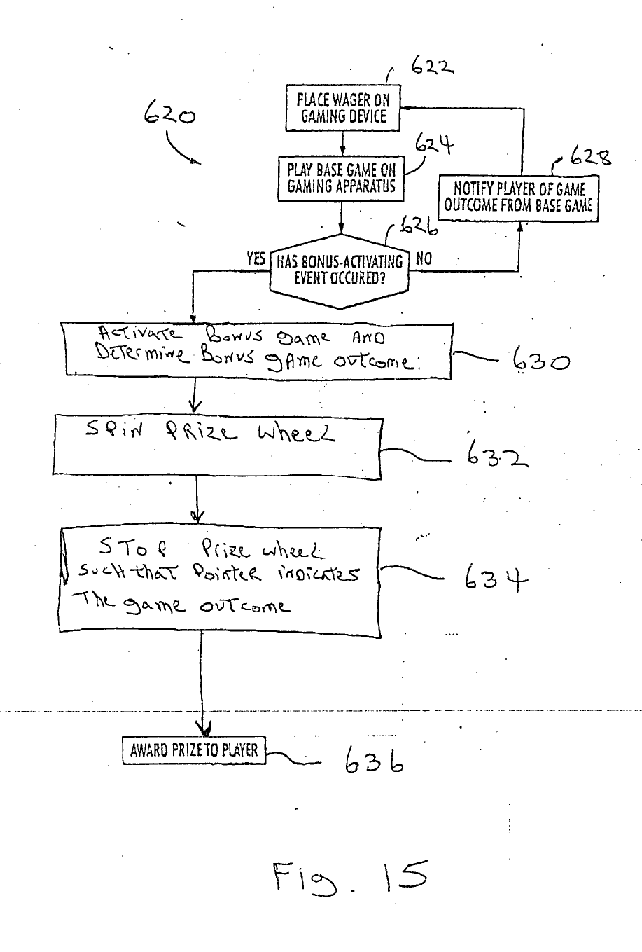

With reference now to FIGS. 13 and 14, a gaming device 500 is shown. Gaming device 500 can include a bonus game or display 502 that is mounted on top of primary or base gaming apparatus 20. Gaming apparatus 20 is the same as previously described in FIGS. 1A-1E. Gaming apparatus 20 includes an organic light emitting diode display 432-436 or 452-456 mounted to reels 22-26 as previously described for FIGS. 1A-1E.

Bonus game 502 has a housing 504 with a front panel 506. A round prize wheel 510 is mounted in housing 504 and extends through a portion of front panel 506. Prize wheel 510 is highly visible to a game player playing game apparatus 500. Prize wheel 510 can be rotated or spun. Prize wheel 510 can be divided into several pie shaped segments 512 that contain an indicia or symbol 514. Indicia 514 can be used to show a game outcome or prize. Indicia 514 can be a wide variety of symbols such as numbers or multipliers. Indicia 514 can also indicate a variety of physical prizes such as a vacation or car. A pointer 520 is mounted to front panel 506 such that the pointer can point to one of the segments 512 and an indicia 514 in order to display a game outcome. During a bonus game, prize wheel 510 is rotated and stopped in a desired location such that the prize to be awarded is aligned with pointer 520. If desired pointer 520 can be illuminated.

Turning now to FIG. 14, bonus game 502 comprises a controller 76 that is adapted to control the operation of the device. Controller 76 may be one or more computers or processor boards. For example, in the presently implemented embodiment, controller 76 comprises a bonus controller and stepper motor controller. It is recognized that controller 76 may be a single processor or processor board. Furthermore, it is also recognized that controller 76 and controller 82 may be combined in a single processor or processor board.

Controller 76 is adapted to detect when a bonus activating event occurs in game apparatus 20. This may be accomplished by game apparatus controller 82 transmitting a signal to controller 76 that a bonus event has occurred. For example, controller 82 may determine the outcome of each game and when a bonus-activating outcome occurs, it transmits a signal to controller 76. Alternatively, controller 76 may periodically interrogate controller 82.

In FIG. 14, the embodiment of FIG. 1E for gaming apparatus 20 is shown in the schematic diagram. Controller 82 is in communication with OLED displays 452-456 through cables 464. Alternatively, the embodiment of FIGS. 1C and 1D can also be used.

In another embodiment, one or more sensors may be provided for determining if a bonus activating event has occurred. For example, sensors 84-86 may sense the positions of reels 22-24. When reels 22-24 are in a bonus activating position, controller 76 would sense this position and begin a bonus sequence (described below). Sensors may also be provided external to gaming device 10 to detect external bonus-activating events. In the embodiment where stationary OLED displays 452-456 are used on reels 22-24, sensors 84-86 are not required and may be omitted.

Controller 82 may also transmit a variety of information to controller 76. For example, controller 82 may signal when coins or currency have been inserted, when a game starts, when an error has occurred, and when a sensor detects tampering.

When controller 76 detects a bonus-activating event, it may begin a bonus sequence by activating display 524. Display 524 may comprise many different kinds of display devices, such as video screens, lights, light emitting diodes, etc. Display 524 may comprise its own controller that is adapted to generate a variety of displays.

Display 524 may indicate that a player has qualified for a bonus round and prompt the player to perform an action. In the preferred embodiment, the player is prompted to activate the bonus sequence by pressing input device 90. Input device 90 may be a simple button, a keyboard, or a touch screen display. In the embodiment in which the player must accumulate a number of bonus symbols to qualify for a bonus, display 524 may indicate the number of symbols the player has received.

When controller 76 detects input device 90 being activated, the controller would activate stepper motor 560 and cause prize wheel 510 to begin to rotate. Controller 76 is in communication with stepper motor 560. Altematively, prize wheel 510 may begin to rotate automatically. In another embodiment, controller 76 may wait a predetermined time period for the player to activate input device 90. If the player does not activate input device 90 in that time period, controller 76 would automatically rotate prize wheel 510 and initiate the display sequence. In yet another embodiment, controller 76 automatically initiates the display sequence in a predetermined time period, independent from input device 90. Of course, no input device may be used and controller 76 may automatically activate bonus game 502.

To determine which prize indicia is to be displayed, controller 76 performs a routine. This may be performed by a number of methods that are well known in the art. Controller 76 can generate a random number and then compares the random number to a pay table similar to that described for game apparatus 20 or as described in U.S. Pat. No. 5,823,874, issued to Adams. A simple pay table may appear as follows:

TABLE 1

| Random | Prize Wheel | Amount |
|---|---|---|
| Number | Segment | Paid |
| 0.00 to 0.50 | 5 | $5.00 |
| 0.51 to 0.75 | 10 | $10.00 |
| 0.76 to 0.95 | 20 | $20.00 |
| 0.96 to 1.00 | 100 | $100.00 |

For example, if the random number generator produced 0.65, the prize wheel would be stopped to display 10 and $10.00 would be awarded to the player. If the random number generator produced 0.80, the prize wheel would show 20 and $20.00 would be awarded to the player. Other prizes may also be awarded such as tickets from an internally or externally mounted dispenser 111. Such dispensers are well known in the art.

Once controller 76 determines the prize indicia to be displayed and the prize to be awarded, the controller activates a positioning mechanism 570. Positioning mechanism 570 is adapted to rotate and stop prize wheel 510 so that in combination with pointer 520, one of prize indicia 514 can be indicated as a game outcome or prize. Positioning mechanism 570 may utilize a large variety of devices to achieve its purpose. Positioning mechanism 570 includes prize wheel 510 that is connected to a shaft 572. Shaft 572 is connected with stepper motor 560.

Prize wheel 510 can be made from a variety of materials, such as plastics, metals, or composites. Stepper motor 560 rotates prize wheel 510. Another wheel 574 can be attached to shaft 572 and a sensor 71, not attached are provided for determining the angular position of the prize wheel. Thus, controller 76 can position the prize wheel 510 and monitor its angular position. The angular position of each indicia 514 is stored in memory in controller 76. Sensor 71 may be an infrared source and detector and the periphery of wheel 74 may comprise portions with different reflective characteristics, such as physical holes or gaps or absorbent paint lines.

Alternatively, an optical flag configuration similar to that described in U.S. Pat. No. 4,911,449, issued to Bertram, may be used.

After prize wheel 510 has been stopped, controller 76 may cause display 110 to display the prize, if any, that the player has won. Other effects may also be presented, such as pre-recorded sound from speakers. If the actual prize is money, the amount of the prize may be added to the player's credit meter or the prize may be dispensed from dispenser 111 or coin dispenser 27.

Game Play Flow Chart

Referring now to FIG. 15, a flowchart of a game play 620 for gaming device 500 is 5 shown. At step 622, a player preferably initiates game play 620 by placing a wager on the gaming device 500. The wager may be in form of cash or credit from actual domestic or foreign currency, vouchers, coupons, tickets, electronic cards, and other sources or forms of wagers known in the art. Once the player initiates game play 620, the player may play a primary or base game on the gaming apparatus at step 624. At step 626, the controller (not shown) detects the occurrence of a bonus-activating event. If the controller does not detect a bonus-activating event, then the controller notifies the player of the game outcome from the base game at step 628. The player may place a wager again and repeat steps 622 and 624 to continue playing a game on the gaming apparatus.

If the controller detects a bonus-activating event, the controller activates the bonus game 502 and determines the bonus game outcome at step 630. The controller then rotates or spins prize wheel 510 at step 632. At step 634, the controller stops prize wheel 510 at the selected location such that the prize wheel and pointer in combination indicate one of prize indicia 514 as the game outcome. Any prizes from the bonus game are awarded to the player at step 636.

The steps shown in the flowchart do not necessarily imply that the steps have to take place in a particular order. The order of steps may be varied; some steps may be eliminated; and, some steps may be replaced with other steps. Such variations still fall within the scope of the invention.

Prize Wheel Having an Organic Light Emitting Diode Display Embodiment

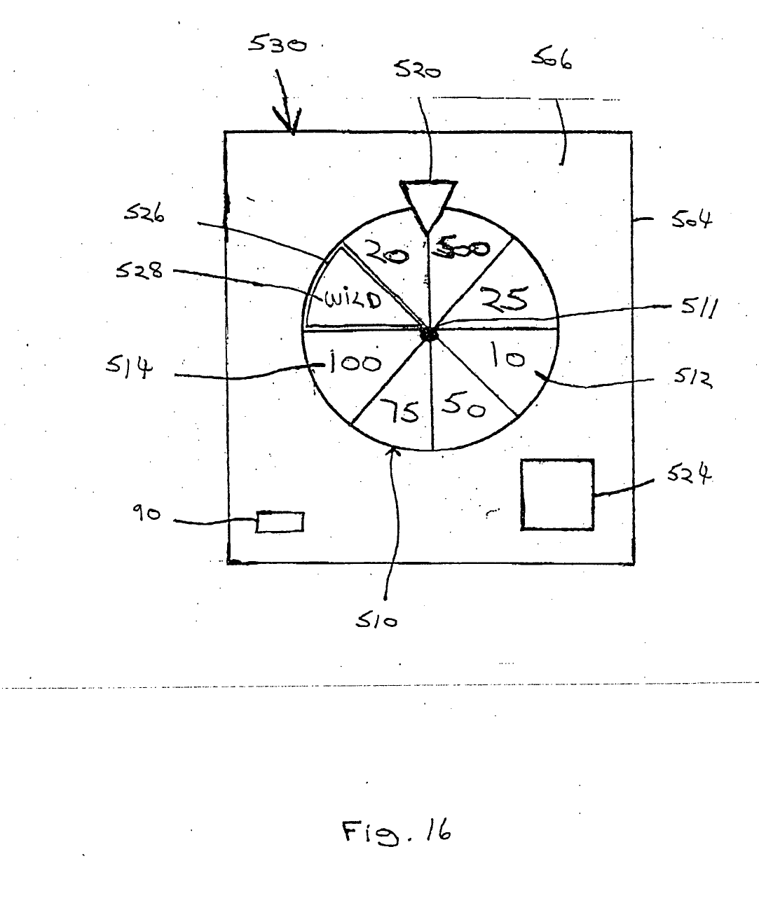

With reference now to FIG. 16, a bonus game or display 530 is shown. Display 530 can be mounted on top of primary or base gaming apparatus 20. Display 530 would be in communication with gaming apparatus 20.

Bonus display 530 has a housing 504 with a front panel 506. A round prize wheel 510 is mounted in housing 504 and extends through a portion of front panel 506. Prize wheel 510 is highly visible to a game player. Prize wheel 510 can be rotated or spun. Prize wheel 510 can be divided into several segments 512 that contain an indicia or symbol 514. Indicia 514 can be used to show a game outcome or prize. Indicia 514 can be a wide variety of symbols such as numbers or multipliers. Indicia 514 can also indicate a variety of physical prizes such as a vacation or car. One of segments 512 in wheel 510 is replaced with an organic light emitting diode display 526. OLED display 526 is pie shaped. OLED display 526 can display a wide variety of symbols or indicia 528. In FIG. 16, indicia 528 is shown as a wild card symbol that can display any desired prize to be awarded.

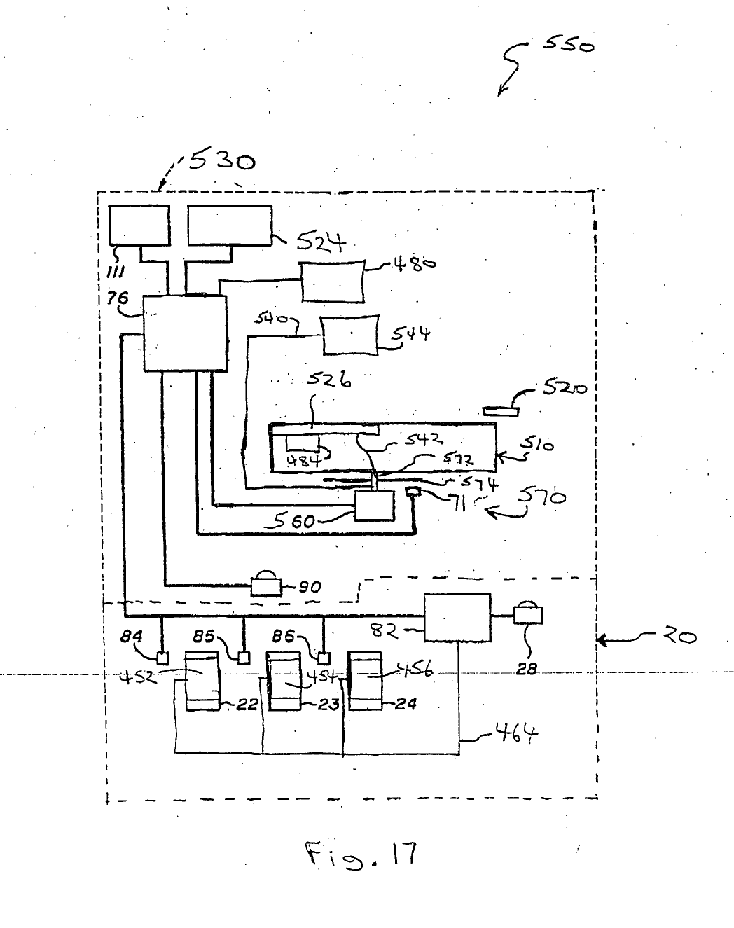

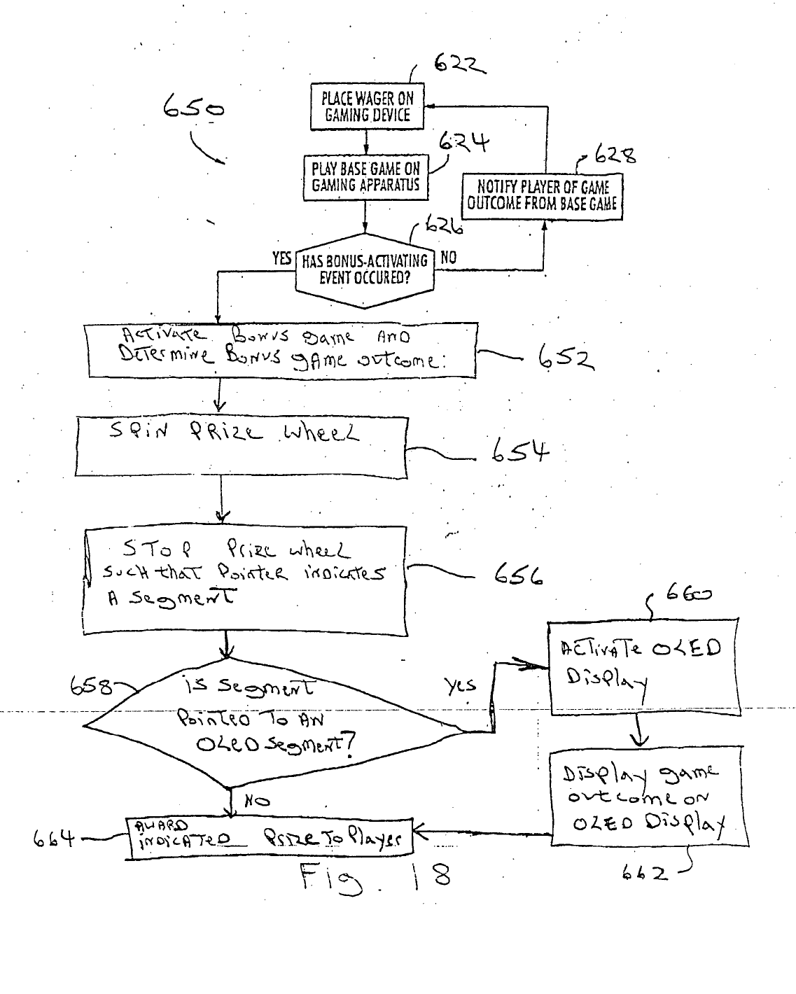

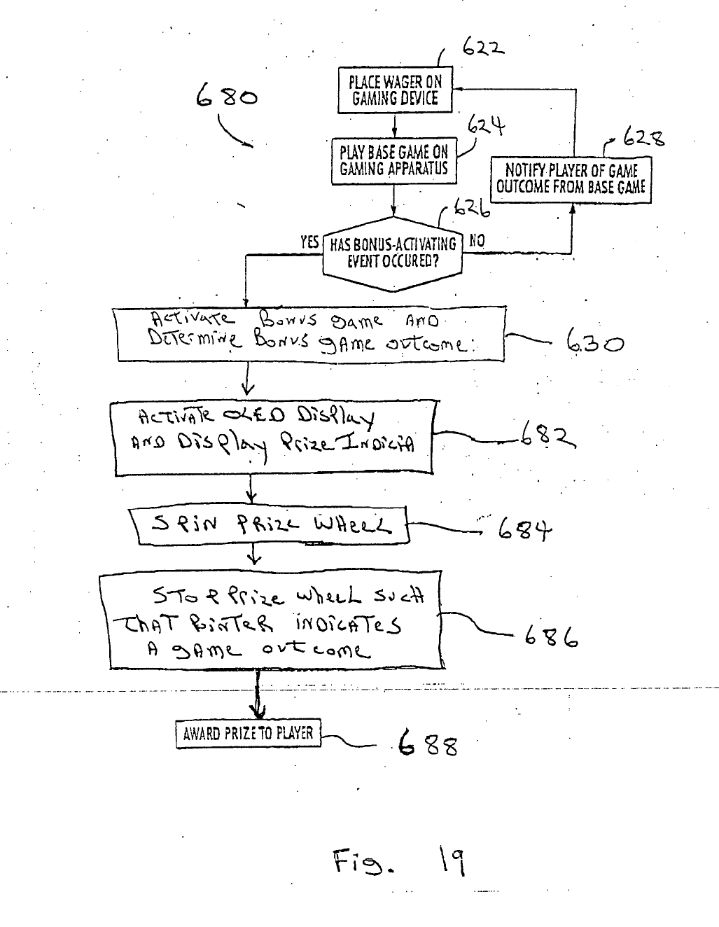

OLED display 526 would be mounted to prize wheel 510 and would be provided with a source of electrical power and communication the same as described in FIG. 1F for display 432. OLED display 526 would be in communication with controller 76 (FIG. 17).

A pointer 520 is mounted to front panel 506 such that the pointer can point to either one of the segments 512 or to OLED display 526 in order to display a game outcome. During a bonus game, prize wheel 510 is rotated and stopped in a desired location such that the prize to be awarded is aligned with pointer 520.

The use of OLED display 526 allows display 530 to be operated in a variety of modes. In one mode, OLED display 526 can display a prize indicia, then prize wheel 510 is rotated and stopped where pointer 520 indicates one either of segments 512 or OLED display 526 as indicating a game outcome or prize. In another mode, OLED display 526 can be left blank or can display an entertaining presentation. Next, wheel 510 is rotated and stopped. If pointer 520 is pointing to OLED display 526, OLED display 526 is driven to display a game outcome or prize.

Turning now to FIG. 17, game apparatus 550 includes a gaming device 20 and a display 530. Display 530 comprises a controller 76 that is adapted to control the operation of the device. Controller 76 may be one or more computers or processor boards. For example, in the presently implemented embodiment, controller 76 comprises a bonus controller and stepper motor controller. It is recognized that controller 76 may be a single processor or processor board. Furthermore, it is also recognized that controller 76 and controller 82 may be combined in a single processor or processor board.

Controller 76 is adapted to detect when a bonus activating event occurs in game apparatus 20. This may be accomplished in the same manner as previously described for game apparatus 20.

When controller 76 detects a bonus-activating event, it may begin a bonus sequence by activating display 524 and stepper motor 560 and cause prize wheel 510 to begin to rotate. Controller 76 is in communication with transmitter 480. OLED display 526 is supplied with power from a power supply 544 through electrical cables 540 and 542. Electrical cable 542 would be connected with a slip ring the same as was described in FIG. 1F. Transmitter 480 is on communication with receiver 484, which in turn is in communication with OLED display 526.

Controller 76 may display an indicia 528 on OLED display 526 before prize wheel 510 starts to rotate. Alternatively, prize wheel 510 may begin to rotate and then controller 76 may display indicia 528 on OLED display 526. Prize wheel 510 may begin to rotate before or after input device 90 is activated.

If the player does not activate input device 90 in a time period, controller 76 would automatically rotate prize wheel 510 and initiate the display sequence. In yet another embodiment, controller 76 automatically initiates the display sequence in a predetermined time period, independent from input device 90. Of course, no input device may be used and controller 76 may automatically activate the bonus game.

The prize indicia to be displayed are randomly determined by controller 76 in the same manner as previously described for bonus game 502.

Once controller 76 determines the prize indicia to be displayed and the prize to be awarded, the controller activates a positioning mechanism 570. Positioning mechanism 570 is adapted to rotate and stop prize wheel 510 so that in combination with pointer 520, one of prize indicia 514 can be indicated as a game outcome or prize. Positioning mechanism 570 may utilize a large variety of devices to achieve its purpose. Positioning mechanism 570 includes prize wheel 510 that is connected to a shaft 572. Shaft 572 is connected with stepper motor 560.

Prize wheel 510 can be made from a variety of materials, such as plastics, metals, or composites. Stepper motor 560 rotates prize wheel 510. OLED display 526 is attached to prize wheel 510. Another wheel 574 can be attached to shaft 572 and a sensor 71, not attached are provided for determining the angular position of the prize wheel. Thus, controller 76 can position the prize wheel 510 and monitor its angular position. The angular position of each indicia 514 and 528 is stored in memory in controller 76. Sensor 71 may be an infrared source and detector and the periphery of wheel 74 may comprise portions with different reflective characteristics, such as physical holes or gaps or absorbent paint lines. Alternatively, an optical flag configuration similar to that described in U.S. Pat. No. 4,911,449, issued to Bertram, may be used.

If prize wheel 510 is stopped such that one of segments 512 is aligned with pointer 520, the game outcome is shown by indicia 514.

If prize wheel 510 is stopped such that OLED display 526 is aligned with pointer 520, controller 76 can direct OLED display 526 through transmitter 480 and receiver 434 to display a game outcome in the form of indicia 528. Alternatively, indicia 528 could have been displayed prior to prize wheel 510 stopping.

After prize wheel 510 has been stopped, controller 76 may cause display 110 to display the prize, if any, that the player has won. Other effects may also be presented, such as pre-recorded sound from speakers. If the actual prize is money, the amount of the prize may be added to the player's credit meter or the prize may be dispensed from dispenser 111 or coin dispenser 27.

The use of organic light emitting diode display 526 in combination with prize wheel 510 can provide more possible game outcomes to be displayed and can also provide an entertaining display that can attract and retain game players.

While bonus game or display 530 was shown used with gaming apparatus 20 using OLED displays 452, 454 and 456, bonus game 530 could be used with a conventional slot machine without OLED displays mounted to the reels.

While only one segment 512 was shown replaced with an OLED display 526, it is contemplated that several or all of the segment 512 of prize wheel 510 could have an OLED display 526.

Game Play Flow Chart

Referring now to FIG. 18, a flowchart of a game play 650 for gaming device 550 is shown. At step 622, a player preferably initiates game play 650 by placing a wager on the gaming device 550. The wager may be in form of cash or credit from actual domestic or foreign currency, vouchers, coupons, tickets, electronic cards, and other sources or forms of wagers known in the art. Once the player initiates game play 650, the player may play a primary or base game on the gaming apparatus at step 624. At step 626, the controller (not shown) detects the occurrence of a bonus-activating event. If the controller does not detect a bonus-activating event, then the controller notifies the player of the game outcome from the base game at step 628. The player may place a wager again and repeat steps 622 and 624 to continue playing a game on the gaming apparatus.

If the controller detects a bonus-activating event, the controller activates the bonus game 530 and determines the bonus game outcome at step 652. The controller then rotates or spins prize wheel 510 at step 654. At step 656, the controller stops prize wheel 510 at the selected location or segment to be aligned with pointer 520. The pointer in combination with the segment indicia indicates the game outcome. If the segment that is pointed at is a OLED display segment at decision 658, the game proceeds to step 660. If the segment that is pointed to at decision 658 is not an OLED segment, game play 650 proceeds to step 664 where any prizes indicated by the prize wheel and pointer in combination are awarded to the player at step 636. At step 660, the OLED display is activated and an entertaining display may be shown. Next at step 662, the OLED display 526 displays the game outcome or indicia 528. Any prizes are then awarded at step 664.

The steps shown in the flowchart do not necessarily imply that the steps have to take place in a particular order. The order of steps may be varied; some steps may be eliminated; and, some steps may be replaced with other steps. Such variations still fall within the scope of the invention.

Alternative Game Play Flow Chart

Referring now to FIG. 19, a flowchart of a game play 680 for gaming device 550 is shown. At step 622, a player preferably initiates game play 680 by placing a wager on the gaming device 550. The wager may be in form of cash or credit from actual domestic or foreign currency, vouchers, coupons, tickets, electronic cards, and other sources or forms of wagers known in the art. Once the player initiates game play 680, the player may play a primary or base game on the gaming apparatus at step 624. At step 626, the controller (not shown) detects the occurrence of a bonus-activating event. If the controller does not detect a bonus-activating event, then the controller notifies the player of the game outcome from the base game at step 628. The player may place a wager again and repeat steps 622 and 624 to continue playing a game on the gaming apparatus.

If the controller detects a bonus-activating event, the controller activates the bonus game 530 and determines the bonus game outcome at step 630. The controller then activates OLED display 526 and displays a prize indicia 528 at step 682. The controller rotates or spins prize wheel 510 at step 684. At step 686, the controller stops prize wheel 510 at the selected location or segment to be aligned with pointer 520. The pointer in combination with the segment indicia indicates the game outcome. Any prizes are then awarded at step 688.

The steps shown in the flowchart do not necessarily imply that the steps have to take place in a particular order. The order of steps may be varied; some steps may be eliminated; and, some steps may be replaced with other steps. Such variations still fall within the scope of the invention.

Prize Sphere Having an Organic Light Emitting Diode Display Embodiment

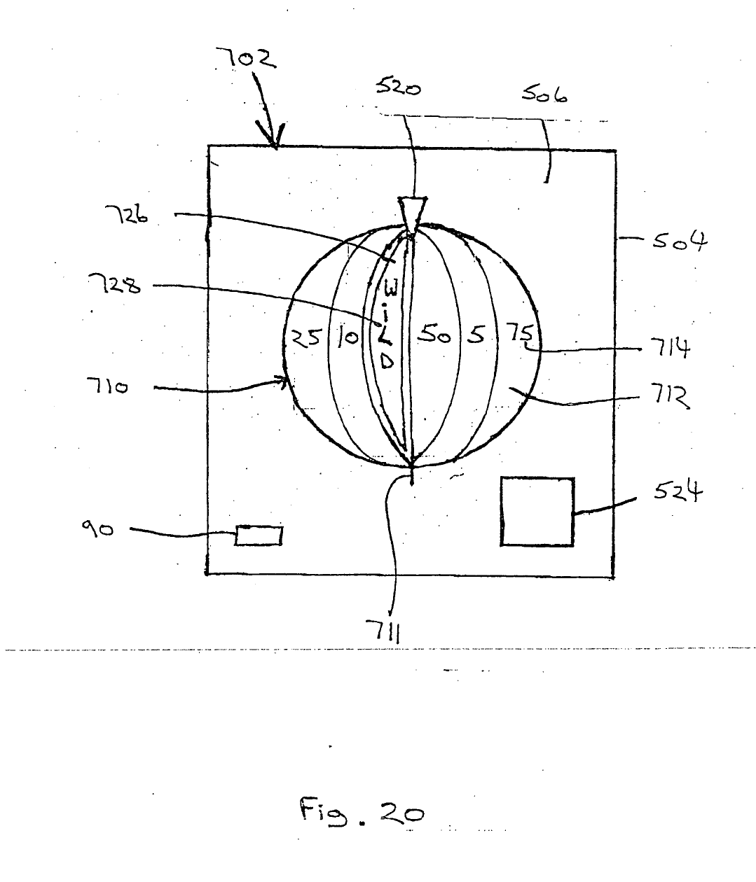

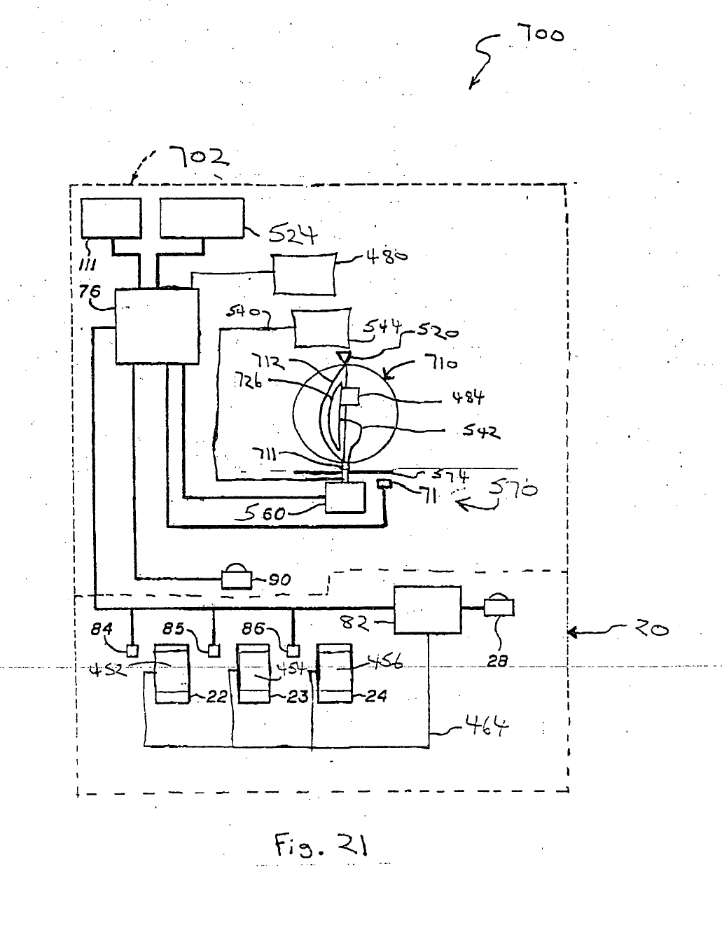

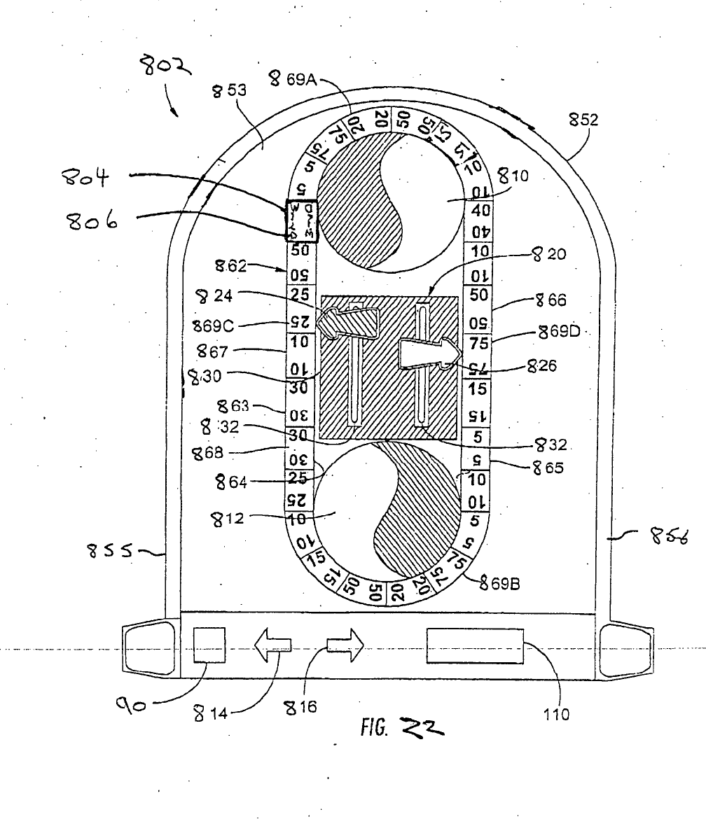

With reference now to FIG. 20, a bonus game or display 702 is shown. Display 702 can be mounted on top of primary or base gaming apparatus 20. Display 702 would be in communication with gaming apparatus 20.

Bonus display 702 has a housing 504 with a front panel 506. A prize globe or sphere 710 is mounted in housing 504. Prize sphere 710 may partially extend through a portion of front panel 506. Prize wheel 510 is highly visible to a game player. Prize sphere 710 may be covered by a transparent cover (not shown) that is attached to front panel 506. Prize sphere 710 can be rotated or spun. Prize sphere 710 can be made to resemble various physical objects. For example, sphere 710 can be made to look similar to a planet, a globe or a ball.

Prize sphere 710 can be divided into several segments 712 that contain an indicia or symbol 714. Indicia 714 can be used to show a game outcome or prize. Indicia 714 can be a wide variety of symbols such as numbers or multipliers. Indicia 714 can also indicate a variety of physical prizes such as a vacation or car. One of segments 712 on sphere 710 is replaced with an organic light emitting diode display 726. OLED display 726 is elliptical in shape. OLED display 726 can display a wide variety of symbols or indicia 728. In FIG. 20, indicia 728 is shown as a wild card symbol that can display any desired prize to be awarded.

OLED display 726 would be mounted to prize sphere 710 and would be provided with a source of electrical power and communication the same as described in FIG. 1F for display 432. OLED display 726 would be in communication with controller 76 (FIG. 21).

A pointer 520 is mounted to front panel 506 such that the pointer can point to either one of the segments 712 or to OLED display 726 in order to display a game outcome. During a bonus game, sphere 710 is rotated and stopped in a desired location such that the prize to be awarded is aligned with pointer 520.

The use of OLED display 726 allows display 702 to be operated in a variety of modes. In one mode, OLED display 726 can display a prize indicia, then prize sphere 710 is rotated and stopped where pointer 520 indicates one either of segments 712 or OLED display 726 as indicating a game outcome or prize. In other mode, OLED display 726 can be left blank or can display an entertaining presentation. Next, sphere 710 is rotated and stopped. If pointer 520 is pointing to OLED display 726, OLED display 726 is driven to display a game outcome or prize.

Turning now to FIG. 21, game apparatus 700 includes a gaming device 20 and a bonus game display 702. Display 702 comprises a controller 76 that is adapted to control the operation of the device. Controller 76 may be one or more computers or processor boards. For example, in the presently implemented embodiment, controller 76 comprises a bonus controller and stepper motor controller. It is recognized that controller 76 may be a single processor or processor board. Furthermore, it is also recognized that controller 76 and controller 82 may be combined in a single processor or processor board.

Controller 76 is adapted to detect when a bonus activating event occurs in game apparatus 20. This may be accomplished in the same manner as previously described for game apparatus 20 of FIG. 2A.

When controller 76 detects a bonus-activating event, it may begin a bonus sequence by activating display 524 and stepper motor 560 and cause prize sphere 710 to begin to rotate. Controller 76 is in communication with transmitter 480. OLED display 726 is supplied with power from a power supply 544 through electrical cables 540 and 542. Electrical cable 542 would be connected with a slip ring the same as was described in FIG. 1F. Transmitter 480 is on communication with receiver 484, which in turn is in communication with OLED display 726.

Controller 76 may display an indicia 728 on OLED display 726 before prize sphere 710 starts to rotate. Alternatively, prize sphere 710 may begin to rotate and then controller 76 may display indicia 728 on OLED display 726. Prize sphere 710 may begin to rotate before or after input device 90 is activated.

The prize indicia to be displayed are randomly determined by controller 76 in the same manner as previously described for bonus game 502.

Once controller 76 determines the prize indicia to be displayed and the prize to be awarded, the controller activates a positioning mechanism 570. Positioning mechanism 570 is adapted to rotate and stop prize sphere 710 so that in combination with pointer 520, one of the prize indicia can be indicated as a game outcome or prize. Positioning mechanism 570 may utilize a large variety of devices to achieve its purpose. Positioning mechanism 570 includes prize sphere 710 that is connected to a shaft 711. Shaft 711 is connected with stepper motor 560.

Prize sphere 710 can be made from a variety of materials, such as plastics, metals, or composites. Stepper motor 560 rotates prize sphere 710. OLED display 726 is attached to prize sphere 710. Another wheel 574 can be attached to shaft 711 and a sensor 71, not attached are provided for determining the angular position of the prize sphere. Thus, controller 76 can position the prize sphere 710 and monitor its angular position. The angular position of each indicia 714 and OLED display 726 is stored in memory in controller 76. Sensor 71 may be an infrared source and detector and the periphery of wheel 74 may comprise portions with different reflective characteristics, such as physical holes or gaps or absorbent paint lines.

If prize sphere 710 is stopped such that one of segments 712 is aligned with pointer 520, the game outcome is shown by indicia 714.

If prize sphere 710 is stopped such that OLED display 726 is aligned with pointer 520, controller 76 can direct OLED display 726 through transmitter 480 and receiver 484 to display a game outcome in the form of indicia 728. Alternatively, indicia 728 could have been displayed prior to prize sphere 710 stopping.

After prize sphere 710 has been stopped, controller 76 may cause display 524 to display the prize, if any, that the player has won. Other effects may also be presented, such as pre-recorded sound from speakers. If the actual prize is money, the amount of the prize may be added to the player's credit meter or the prize may be dispensed from dispenser 111 or coin dispenser 27.

The use of organic light emitting diode display 726 in combination with a prize sphere 710 can provide more possible game outcomes to be displayed and can also provide an entertaining display that can attract and retain game players. While only one segment 712 was shown replaced with an OLED display 726, it is contemplated that several or all of the segment 712 of prize sphere 710 could have an OLED display 726.

Game apparatus 700 can be played in the same manner as previously described in game play 650 shown in FIG. 18 and game play 680 shown in FIG. 19.

Prize Belt Having an Organic Light Emitting Diode Display Embodiment

With reference now to FIG. 22, a bonus game or display 802 is shown. Display 502 can be mounted on top of primary or base gaming apparatus 20 (FIG. 1A). Display 802 would be in communication with gaming apparatus 20.

In at least one embodiment, display device 802 is configured to display a bonus game and at least one bonus prize to the player. In other embodiments, display device 802 may provide a primary game. Alternatively, display device 802 may be a stand-alone device allowing a player to place a wager and play a game.

In at least one embodiment, display device 802 is attached to gaming device 20 and positioned on top of gaming device 20. In other embodiments (not shown), display device 802 may be separate from gaming device 20 but in communication with gaming device 20. In this embodiment, gaming device 20 may be in communication with a plurality of different gaming devices 20 via a computer network in a manner that is well known in the art. Display device 802 may also be positioned adjacent to or remote from gaming device 20. In other embodiments, display device 802 is a stand-alone display not in communication with gaming device 20, and it may be capable of independently accepting wagers, conducting games, and awarding prizes to a player.

With reference to FIGS. 22-24, bonus game 802 may comprise a housing 852. Housing 852 can have a front panel 853, rear panel 854, side panels 855 and 856. The panels can define an internal space or cavity 858. Housing 852 may be made in many different shapes and from any suitable material such as metal or plastic. Housing 852 can include decorative coverings or attachments and lights. Front panel 853 has at least one portion that is transparent defining a window 859 such that display device 802 can be viewed by a game player looking through window 859. Display device 802 is mounted in housing 852. A frame 876 supports display device 802 in housing 852. Display device 802 can have a button 90 that is used to activate display device 802 and a display 110 that is used to display prizes or credits won.

Display device 802 may comprise a prize belt or prize band or material 862 that rotates about rollers 872 and 874. Prize belt 862 can have an outer surface 863, an inner surface 864, a front surface 865 and a back surface 866. Prize belt 862 can have a plurality of prize positions 867 located on front surface 865. Prize belt 862 may have a plurality of prize indicia 868 appearing on front surface 865 in prize positions 867. Front surface 865 can be relatively wide in order to hold indicia 868 that are large enough to be easily readable. Indicia 868 may indicate various prizes, such as an award of currency or credits, merchandise, services, game play, jackpots, and progressive prizes. Prize belt 862 may have a variety of different indicia 868 imprinted or otherwise appearing thereon. Indicia 868 may vary in number, size and content. It may be desirable to arrange indicia 868 on belt 862 such that enough of each type of indicia 868 are included in order that any indicia can be indicated at any position to which belt 862 is moved.

Indicia 868 can be arranged in a duplicate manner in each prize position 867 as is shown in FIG. 22. The duplicate indicia are arranged to be opposite or a mirror image to each other. Some of the indicia would appear upright and some would appear to be upside down. The use of duplicate indicia allows at least one of the duplicate indicia to be viewable by the game player in an upright readable manner regardless of the belt position.

One of the prize positions 867 on belt 862 has an organic light emitting diode display 804. OLED display 804 is rectangular in shape and rotates as belt 862 is rotated. OLED display 804 can display a wide variety of symbols or indicia 806. In FIG. 22, indicia 806 is shown as a wild card symbol that can display any desired prize to be awarded.

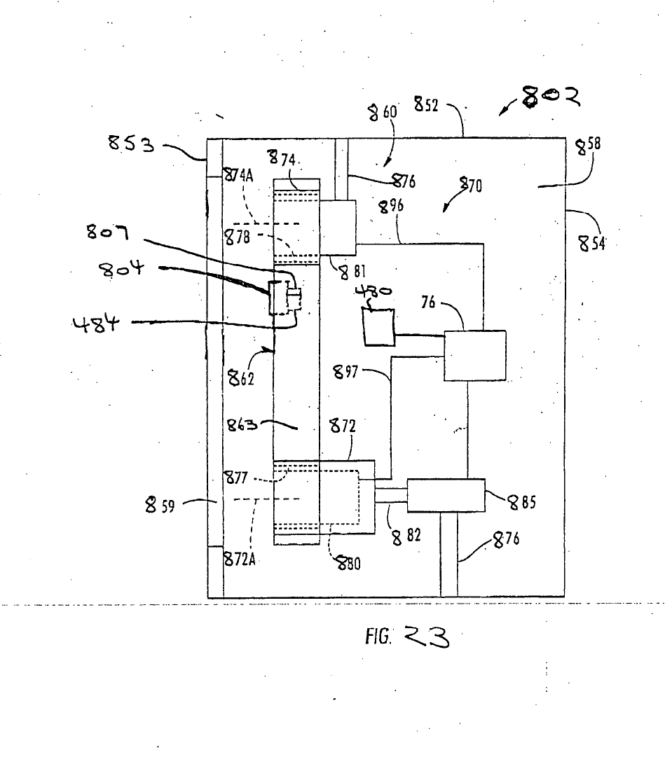

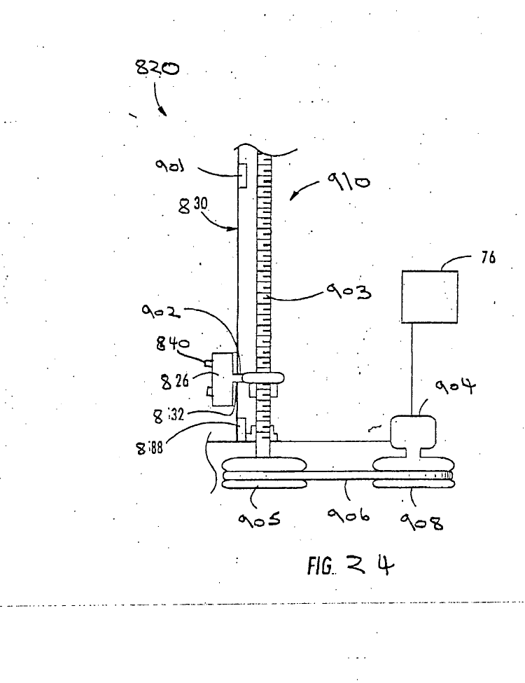

OLED display 804 would be mounted to prize belt 862 and would be provided with a source of electrical power and communication the same as described in FIG. 1F for display 432. OLED display 804 would be in communication with controller 76 (FIG. 21). As shown in FIG. 23, a battery 807 can also be mounted with OLED display 804 and be used to power the OLED display in conjunction with wireless receiver 484 and transmitter 480.

Belt 862 can have curved portions 869A and 869B that wrap around a pair of rollers and elongated portions 869C and 869D that extend between the rollers.

Belt 862 may resemble a conveyor belt. Belt 862 may be constructed from any suitable material. Belt 862 may be constructed from a flexible material, such as various types of vinyl, plastic, rubber materials, and the like. The use of a flexible material may prevent belt 862 from tearing when it is moved. The material used to construct belt 862 may be transparent or translucent, allowing belt 862 to be backlit.

In an alternative embodiment, belt 862 may also be formed from several pivotally connected segments and may resemble a tractor tread.

Belt 862 may be coupled to a display or belt positioning mechanism 870 so that belt 862 may be rotated about rollers 872 and 874. FIG. 23 illustrates belt 862 wrapped around rollers 872 and 874. Rollers 872 and 874 are in frictional contact with inner surface 864. Roller 872 has an axis of rotation 872A and roller 874 has an axis of rotation 874A. The axes of rotation 872A and 874A are perpendicular to the length of belt 862. Positioning mechanism 870 comprises roller 872 that is a driven roller and roller 874 is an idle roller. Bearing 877 is located between driven roller 872 and a stationary hub 880. Bearing 878 is mounted between idle roller 874 and a stationary hub 881. Driven roller 872 may be connected by a shaft 882 to a stepper motor or actuator 885 in order to drive rotation of driven roller 872. Actuator 885 may be any number of suitable actuators, such as motors, including stepper motors, gear motors, and servo motors. Actuator 885 is in communication with a controller 76.

In at least one embodiment, belt 862 is driven simply by frictional contact between belt 862 and driven roller 872. A tensioning mechanism (not shown) can be provided to maintain the proper tension on belt 862.

Front surface 865 is oriented such that it is visible to a game player looking into window 859. When viewed by the game player, the entire front surface 865 is visible including the portions 869A and 869B that wrap around rollers 872 and 874 and the elongated portions 869C and 869D that extend between the rollers. It is noted that the axis of rotation of belt 862 is parallel to the line of sight of a game player viewing the belt. This allows the entire front surface 865 of the belt including portions 869A-869D to be viewed in a rotating manner by the game player.

In at least one embodiment, display device 802 includes several movable indicators 820 that are mounted between inner surfaces 864 and covers 810 and 812. In another embodiment, indicators 820 can be stationary. Cover 810 covers hub 880 and cover 812 covers hub 881. Indicators 820 can include a linearly movable left indicator 824 and a linearly movable right indicator 826. The indicators are mounted in front of a cover 830 that can be part of front panel 853. Cover 830 has a pair of slots 832. Indicators 820 are mounted such that they can be moved and viewed through a portion of front panel 853. Indicators 820 are in communication with controller 76.

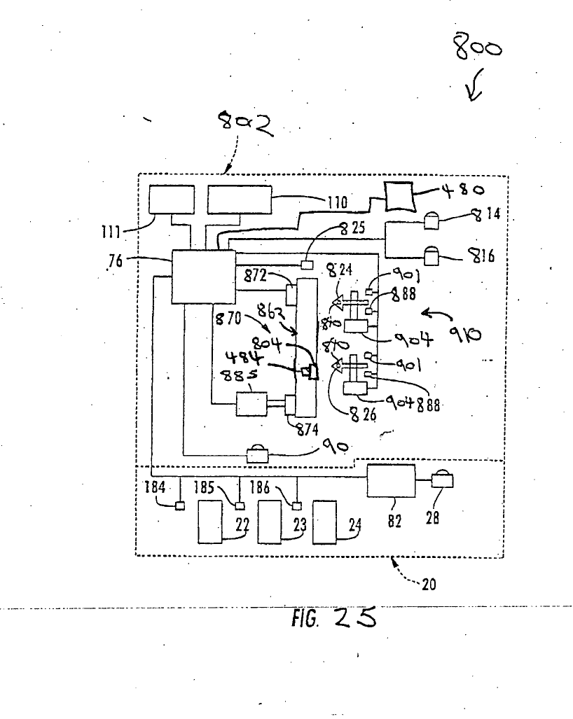

Referring now to FIG. 24, indicators 820 may be coupled to an indicator positioning mechanism 910. Indicator positioning mechanism 910 can linearly move indicators 820 in a vertical manner. Indicators 820 could also be moved horizontally if desired.

FIG. 24 shows indicator 826 coupled to indicator positioning mechanism 910. Indicator positioning mechanism 910 may be located within the confines of housing 852. Slot 832 in cover 830 allows a bracket 902 to pass through the cover. Positioning mechanism 910 may comprise a worm gear 903 that can be rotated by an actuator 904. In at least one a embodiment, actuator 904 is attached to a first wheel 908. Worm gear 903 may be attached to a second wheel 905. A drive belt 906 preferably rotates around the first wheel 908 and second wheel 905, thereby connecting actuator 904 and worm gear 903. Positioning mechanism 910 may communicate with controller 76, which may store information regarding pre-determined positions of belt 862. Sensors 888 and 901 are preferably in communication with controller 76 and may be provided to allow controller 76 to detect the position of indicators 820. Other devices may be used to detect the position of indicators 820, such as optical readers and the like.

Indicators 820 preferably are made from a translucent material such as plastic and can include one or more lights 840 (FIG. 24) that are mounted within or behind indicators 820. Lights 840 can call attention to indicators 820 and make indicator 820 more attractive. Lights 840 may be of any suitable type, including light emitting diodes (LEDs). Lights 840 are in communication with controller 76. Lights 840 can be connected to a power source through a flexible cable (not shown) or can use a battery and wireless communications to turn lights 840 on and off.

In at least one embodiment, one or more of lights 840 are turned on or illuminated in one of indicators 824 or 826 such that one of the indicators points to a selected prize indicia 868 on belt 862 and indicates a game outcome to the game player. In FIG. 22, indicator 826 is shown illuminated and pointing to an indicia having a value of 75 credits.

The use of OLED display 804 allows display 802 to be operated in a variety of modes. In one mode, OLED display 804 can display a prize indicia 806, then prize belt 862 is rotated and stopped. One of indicators 824 and 826 indicate a game outcome in either prize positions 867 or in OLED display 804. In other mode, OLED display 804 can be left blank or can display an entertaining presentation. Next, prize belt 862 is rotated and stopped. If one of indicators 824 or 826 is pointing to OLED display 804, OLED display 804 is driven to display a game indicia 806 indicating a game outcome or prize.

Alternatively, indicators 820 could be replaced by a video display (not shown) that displays a video presentation of the indicators. The video display can move, highlight and flash the indicators to indicate a game outcome.

FIG. 22 also has player input devices 814 and 816 that allow the player to indicate his or her choice. In one preferred embodiment, player input devices 814 and 816 are buttons that allow the player to select one of indicators 824 or 826 to display a prize. For example, the player would press the left button 814 to select the left indicator 824 to point to a prize indicia 868. The player would press the right button 816 to select the right indicator 826 to point to a prize indicia 68. Alternatively, a touch screen (not shown) may be provided in place of or in addition to buttons 814 and 816.

Player input devices 814 and 816 allow a game player to partially control the outcome of bonus game 802. While the player is allowed to select which indicators 824 or 826 display the prize indicia, the final prize indicia 868 that is displayed is controlled by controller 76.

The use of the player input devices 814 and 816 provides the game player with an illusion of control over the game. Of course, regulatory concerns may dictate that the player's perceived control be largely or completely illusionary.

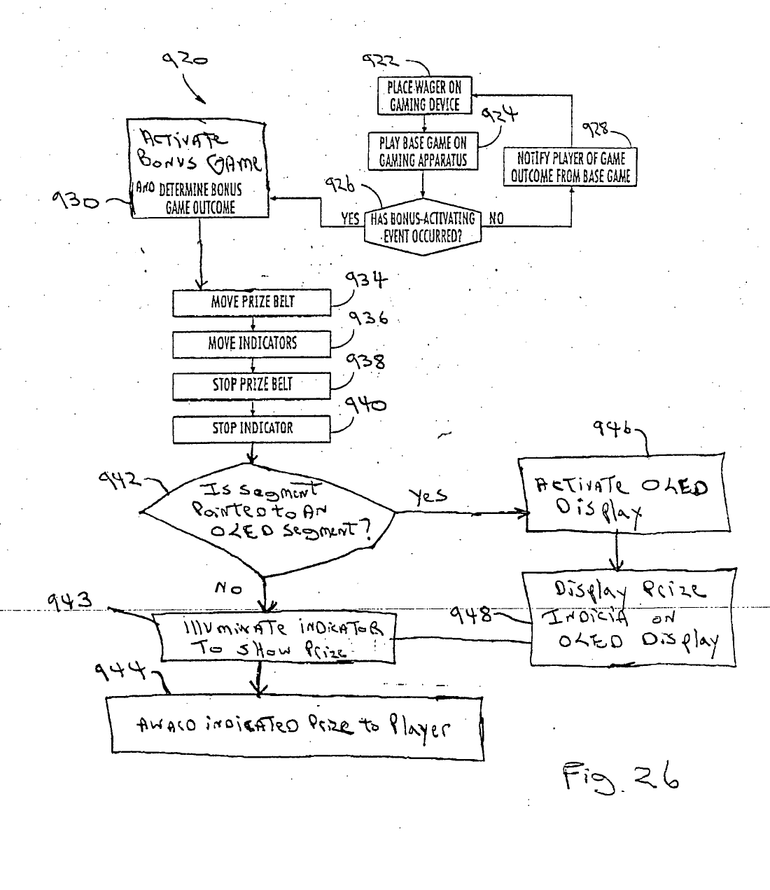

Turning now to FIG. 25, bonus game apparatus 802 comprises a controller 76 that is adapted to control the operation of the game apparatus. The operation of controller 76 and game apparatus 20 are the same as previously described for FIG. 2A. In FIG. 25, the OLED displays 452-456 are omitted.

When controller 76 detects input device 90 being activated, the controller would activate stepper motor or actuator 885 causing belt 862 to begin to rotate or spin and moving indicators 820. Controller 76 is in communication with transmitter 480. OLED display 804 can be supplied with power from battery 807 (FIG. 23). Transmitter 48O is in communication with receiver 484, which in turn is in communication with OLED display 804.

Controller 76 may display an indicia 806 on OLED display 804 before or after prize belt 862 starts to rotate. Alternatively, indicia 806 may be displayed after prize belt 862 is stopped. Prize belt 862 may begin to rotate before or after input device 90 is activated. The prize indicia to be displayed are randomly determined by controller 76 in the same manner as previously described for bonus game 502.

Once controller 76 determines the prize indicia to be displayed and the prize to be awarded, the controller activates display positioning mechanism 870 and indicator positioning mechanism 910. Display positioning mechanism 870 and indicator positioning mechanism 910 are adapted to position and indicate at least one selected prize indicia 868 or 806 so that it can be displayed. Positioning mechanisms 870 and 910 may utilize a large variety of devices to achieve its purpose. In an embodiment, belt 862 and indicators 820 are moved to a position where one of indicators 820 are illuminated to point to one of prize indicia 868 or 806.

Display positioning mechanism 870 comprises a stepper motor 885 for rotating and stopping belt 862. A sensor 825 can be provided for determining the position of belt 862. The position of each indicia 868 and OLED display 804 is stored in memory in controller 76. Stepper motor 885 can stop belt 862 at the location determined by the random number generator.

Sensor 125 can be any suitable sensor. For example, sensor 825 may be an infrared source and detector and belt outer surface 863 may comprise portions with different reflective characteristics, such as physical holes or gaps or absorbent paint lines.

Alternatively, a side of belt 862 can contain a series of holes (not shown), cut-out portions, or similar optical intermits. The optical interrupts may be read by an optical reader (not shown). The optical interrupts may convey the position of belt 862 to controller 76. Sensor 825 may be used to verify that the belt is in the proper position. If sensor 825 does not detect the belt in its proper position, controller 76 may enter an error mode.

Indicator positioning mechanism 910 comprises a pair of actuators 904 for moving and stopping indicators 824 and 826. Rotating actuator 904 turns wheel 905 and wheel 908 through belt 906. The rotation of wheel 905 turns worm gear 903 causing the movement of indicators 824 and 826. Sensors 888 and 901 can be provided for determining the position of indicators 824 and 826. Sensors 888 and 901 can be any suitable sensor. Actuator 904 can stop indicators 824 and 826 at the location determined by controller 76.

After controller 76 has determined which prize indicia is to be displayed, the controller rotates belt 862 and moves indicators 824 and 826 until the desired prize indicia 868 or OLED display 804 is aligned with the desired indicator that is to be illuminated. At the appropriate time, controller 76 stops belt 862, stops indicators 824 and 826 and illuminates or turns on one of lights 840 behind a corresponding indicator. This allows the game player to view a prize. If the OLED display 804 did not previously display a prize indicia 806, controller 76 causes OLED display 804 to display prize indicia 806.

Controller 76 may then cause display 110 to display the prize, if any, that the player has won. Other effects may also be presented, such as pre-recorded sound from speakers. If the actual prize is money, the amount of the prize may be added to the player's credit meter or the prize may be dispensed from dispenser 111 or coin dispenser 27.

Combinations of prize indicia 868 and 806 can be used to indicate various bonus outcomes. For example, indicator 824 could point to a prize indicia 868 and indicator 826 could point to prize indicia 806. The two prize indicias could be added and awarded as a total prize to the game player.

In an alternative embodiment, one of indicators 824 or 826 could first be illuminated and then the rotation of belt 862 can be stopped in order to display a game outcome.

It is also possible to replace the primary display of a gaming device with display device 802. Game apparatus 20 may be entirely replaced by display device 802. In other words bonus gaming apparatus 802 can be used as a primary or base game apparatus.

In another embodiment, the player could be allowed to select which indicator points to the prize or game outcome. For example, the player could use player input devices 814 and 816 to select one of indicators 824 or 826 to display a prize. The player could press the left button 814 to select the left indicator 824 (FIG. 22). Controller 76 would illuminate indicator 824. Controller 76 would then rotate and stop belt 862, move and stop indicator 824 and drive OLED display 804 to display the game outcome.

Alternatively, belt 862 could be stopped prior to the game player's selection using input devices 814 and 816. Alternatively, the indicators 820 could be stopped prior to the game player's selection using input devices 814 and 816.

Game Play Flow Chart

Referring now to FIG. 26, a flowchart of a game play 920 for gaming device 800 is shown. At step 922, a player preferably initiates game play 920 by placing a wager on the gaming device 800. The wager may be in form of cash or credit from actual domestic or foreign currency, vouchers, coupons, tickets, electronic cards, and other sources or forms of wagers known in the art. Once the player initiates game play 920 the player may play a primary or base game on the gaming apparatus at step 924. At step 926, the controller (not shown) detects the occurrence of a bonus-activating event. If the controller does not detect a bonus-activating event, then the controller notifies the player of the game outcome from the base game at step 928. The player may place a wager again and repeat steps 922 and 924 to continue playing a game on the gaming apparatus.

If the controller detects a bonus-activating event, the controller activates the bonus game 802 and determines the bonus game outcome at step 930. The controller then rotates or spins prize belt 862 at step 934. At step 936, the controller moves indicators 820. At step 938, the prize belt 938 is stopped. Indicators 820 are stopped at step 940. The indicator in combination with the indicia indicates the game outcome. If the OLED display 804 is pointed to by one of indicators 824 or 826, at decision 942, the game proceeds to step 946. If the prize position 867 segment that is pointed to at decision 942 is not an OLED display, game play 920 proceeds to step 943 where one of indicators 824 or 826 is illuminated to show the game outcome. Any prizes indicated by the prize belt and indicator in combination are awarded to the player at step 944. At step 946, the OLED display is activated and an entertaining display may be shown. Next at step 948, the OLED display displays the game outcome or indicia. Any prizes are then awarded at step 944.

The steps shown in the flowchart do not necessarily imply that the steps have to take place in a particular order. The order of steps may be varied; some steps may be eliminated; and, some steps may be replaced with other steps. Such variations still fall within the scope of the invention.

Alternative Game Play Flow Chart

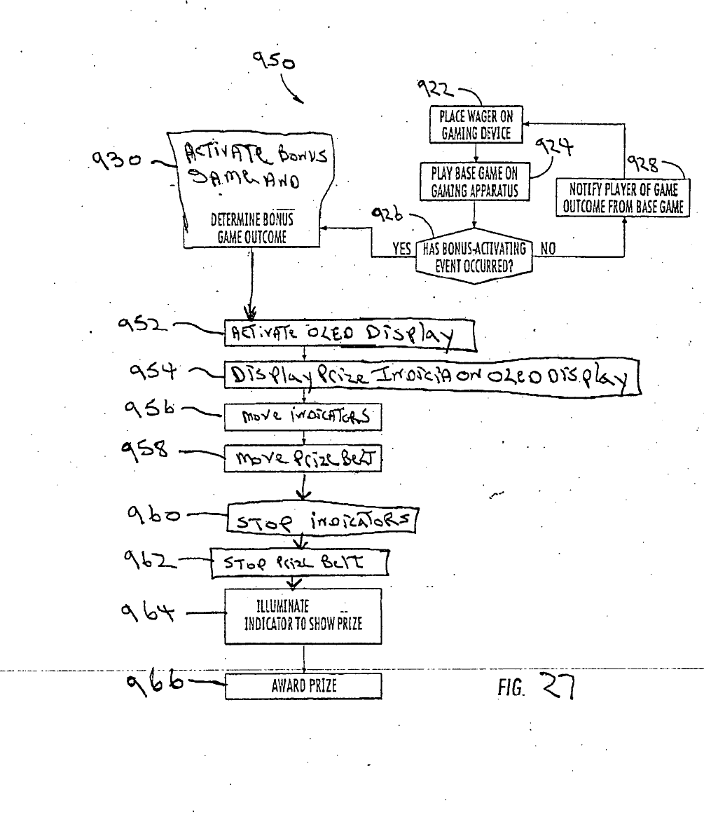

Referring now to FIG. 27, a flowchart of a game play 950 for gaming device 800 is shown. At step 922, a player preferably initiates game play 950 by placing a wager on the gaming device 800. The wager may be in form of cash or credit from actual domestic or foreign currency, vouchers, coupons, tickets, electronic cards, and other sources or forms of wagers known in the art. Once the player initiates game play 950, the player may play a primary or base game on the gaming apparatus at step 924. At step 926, the controller (not shown) detects the occurrence of a bonus-activating event. If the controller does not detect a bonus-activating event, then the controller notifies the player of the game outcome from the base game at step 928. The player may place a wager again and repeat steps 922 and 924 to continue playing a game on the gaming apparatus.

If the controller detects a bonus-activating event, the controller activates the bonus game 802 and determines the bonus game outcome at step 930. The controller then activates OLED display 804 at step 952. Prize indicia 806 is shown at step 954. Indicators 820 are moved at step 956. The controller rotates or moves prize belt 862 at step 958. At step 960, the controller stops the indicators 820. Prize belt 962 is stopped at step 962. One of indicators 824 or 826 is illuminated at step 964. The lighted indicator in combination with the prize position indicia indicates the game outcome. Any prizes are then awarded at step 966.

The steps shown in the flowchart do not necessarily imply that the steps have to take place in a particular order. The order of steps may be varied; some steps may be eliminated; and, some steps may be replaced with other steps. Such variations still fall within the scope of the invention.

It can thus be seen that the preferred embodiments can solve one or more problems associated with the prior art or provide advantages over prior art devices. One embodiment of the present invention provides a gaming device that utilizes an organic light emitting diode display that may be used with a primary game and a bonus game. The organic light emitting diode display can provide more game outcomes to a gaming operator and reduce the level of maintenance required for the gaming device.

Although the description above contains many specifications, these should not be construed as limiting the scope of the invention but as merely providing illustrations of some of the presently preferred embodiments of this invention. This specification above, for instance, makes reference to bonus prizes. However, the present invention is not thereby intended to be limited to providing bonus prizes. Rather it is intended that the present invention can, in certain embodiments, be used independently as a stand-alone game without necessarily including bonusing. Thus, the scope of the invention should be determined by the claims as issued and their legal equivalents rather than by the preferred examples given.

### CONCLUSION

Accordingly, the present invention provides a gaming device that includes an organic light emitting diode display and several bonus games. The light emitting diode display can rotate or be stationary. The organic light emitting diode display can show an unlimited number of indicia or symbols. Not only is the gaming device exciting and enjoyable to view and play, it also increases the number of possible game outcomes.

Although the description above contains many specifications, these should not be construed as limiting the scope of the invention but as merely providing illustrations of some of presently preferred embodiments of this invention. Thus, the scope of the invention should be determined by the appended claims and their legal equivalents rather than by the examples given.

What is claimed is:

1. A gaming device comprising:
(A) a primary game having a plurality of reels;
(B) an organic light emitting diode display mounted to at least one of the reels; and
(C) a bonus game mounted in association with the primary game, the bonus game having a plurality of prize balls and a plurality of display balls, the prize balls being configured to indicate a game outcome.

2. The gaming device of claim 1 wherein the bonus game has a container, the display balls being held in the container.

3. The gaming device of claim 1 wherein the bonus game has a prize ball holder.

4. The gaming device of claim 3 wherein the prize ball holder contains the prize balls.

5. The gaming device of claim 1 wherein a controller is in communication with the organic light emitting diode display and is adapted to show at least one symbol on the organic light emitting diode display.

6. A gaming device comprising:
(A) a primary game having an organic light emitting diode display, the primary game being adapted to display a plurality of symbols on the organic light emitting diode display and to award a base prize;
(B) a bonus game mounted with the primary game, the bonus game being adapted to award a bonus prize, the bonus game having a wheel and a pointer wherein in combination the wheel and the pointer indicate a game outcome; and
(C) a controller in communication with the primary game, the organic light emitting diode display and the bonus game, the controller being adapted to detect at least one bonus activating event in the primary game and to activate the bonus game in response to detecting the bonus activating event.

7. The gaming device of claim 6 wherein the primary game has a plurality of reels, the organic light emitting diode display being mounted to the reels.

8. The gaming device of claim 7 wherein the reels are stationary.

9. The gaming device of claim 6 wherein a second organic light emitting diode display is mounted to the wheel.

10. A gaming device comprising:
(A) a primary game having a plurality of reels;
(B) an organic light emitting diode display mounted to at least one of the reels; and
(C) a bonus game mounted in association with the primary game, the bonus game having a belt and at least one indicator, wherein in combination the belt and the indicator indicate a game outcome.

11. The gaming device of claim 10 wherein a second organic light emitting diode display is mounted to the belt.

12. The gaming device of claim 10 wherein a controller is in communication with the organic light emitting diode display and is adapted to show at least one symbol on the organic light emitting diode display.

13. The gaming device of claim 12 wherein the controller communicates with the organic light emitting diode display using wireless communications.

14. A gaming device comprising:
(A) a primary game having a plurality of reels;
(B) an organic light emitting diode display mounted to at least one of the reels; and
(C) a bonus game mounted in association with the primary game, the bonus game having a sphere and a pointer, wherein in combination the sphere and the pointer indicate a game outcome.

15. The gaming device of claim 14 wherein a second organic light emitting diode display is mounted to the sphere.

16. The gaming device of claim 14 wherein the sphere has a plurality of indicia and is adapted to rotate.

17. A gaming device comprising:
(A) primary game means for playing a primary game;
(B) organic light emitting diode display means mounted to the primary game means for providing a changeable display that can display at least one prize indicia;
(C) bonus game means mounted with the primary game means for allowing a player to play a bonus game, the bonus game means including display means for displaying a plurality of prize indicia and pointer means for indicating at least one of the prize indicia as a game outcome; and
(D) controller means in communication with the primary game means, the display means and the organic light emitting diode display means, the controller means operable to display the prize indicia and to move the display means, wherein in combination the display means and the pointer means indicate at least one of the prize indicia as a game outcome.

18. The gaming device of claim 17 wherein the organic light emitting diode means and the controller means are in wireless communication.

19. A gaming method comprising the following steps, but not all necessarily in the order shown:
(A) allowing a player to play a primary gaming device, the primary gaming device providing at least one bonus qualifying event and having an organic light emitting diode display;
(B) displaying at least one symbol on the organic light emitting diode display;
(C) if the at least one bonus qualifying event occurs, activating a bonus game, the bonus game including a plurality of display balls and a plurality of prize balls;
(D) allowing the player to play the bonus game;
(E) jumbling the display balls;
(F) displaying a prize ball to the player; and
(G) awarding a prize to the player.

20. The gaming method of claim 19 wherein the organic light emitting diode display is mounted to a reel.

21. A gaming method comprising the following steps, but not all necessarily in the order shown:
(A) allowing a player to play a primary gaming device, the primary gaming device having at least one organic light emitting diode display;
(B) displaying at least one symbol on the organic light emitting diode display to the player;
(C) if the symbol indicates a bonus qualifying event, activating a bonus game;
(D) allowing the player to play the bonus game;
(E) moving a wheel having a plurality of prize indicia mounted thereon;
(F) stopping the wheel; and
(G) awarding a prize to the player.

22. The gaming method of claim 21 further comprising scrolling the organic light emitting diode display.

23. A gaming method comprising the following steps, but not all necessarily in the order shown:
(A) allowing a player to play a primary gaming device, the primary gaming device having a plurality of indicia and at least one organic light emitting diode display;
(B) displaying at least one of the indicia on the organic light emitting diode display to the player;
(C) if the indicia indicates a bonus qualifying event, activating a bonus game;
(D) allowing the player to play the bonus game;
(E) moving a sphere having a plurality of segments;
(F) stopping the sphere; and
(G) awarding a prize to the player.

24. The gaming method of claim 23 further comprising using a pointer in combination with the sphere to indicate a game outcome.

25. A gaming method comprising the following steps, but not all necessarily in the order shown:
(A) allowing a player to play a primary game, the primary game having a plurality of indicia and at least one organic light emitting diode display;
(B) displaying at least one of the indicia on the organic light emitting diode display to the player;
(C) if the indicia indicates a bonus qualifying event, activating a bonus game;
(D) allowing the player to play the bonus game;
(E) moving a belt having a plurality of prize positions;
(F) moving an indicator;
(G) stopping the belt;
(H) stopping the indicator; and
(I) awarding a prize to the player.

26. The gaming method of claim 25 further comprising allowing the player to use a player input device.
